(19) United States
(12) Patent Application Publication
(10) Pub. No.: US 2026/0153958 A1
(43) Pub. Date: Jun. 4, 2026

(54) METHOD OF DETERMINING TOUCH SIGNALS FOR A TOUCH SENSOR, DISPLAY DEVICE AND ELECTRONIC DEVICE

(71) Applicants: Samsung Display Co., LTD., Yongin-si (KR); Research & Business Foundation SUNGKYUNKWAN UNIVERSITY, Suwon-si (KR)

(72) Inventors: KEUMDONG JUNG, Yongin-si (KR); JIHOON KIM, Yongin-si (KR); Kaewon Choi, Suwon-si (KR); JANGHUI KIM, Yongin-si (KR); Jiyong Park, Suwon-si (KR); Minjun Jeong, Suwon-si (KR)

(73) Assignees: Samsung Display Co., LTD., Yongin-si (KR); Research & Business Foundation SUNGKYUNKWAN UNIVERSITY, Suwon-si (KR)

(21) Appl. No.: 19/305,963

(22) Filed: Aug. 21, 2025

(30) Foreign Application Priority Data
Nov. 29, 2024 (KR) 10-2024-0175219

(51) Int. Cl. G06F 3/041; G06F 3/044

(52) U.S. Cl. CPC G06F 3/04166; G06F 3/0446

(57) ABSTRACT

A method of determining N×m touch signals for a touch sensor including N×m touch transmission electrodes includes generating an orthogonal matrix including N orthogonal codes, determining a first phase shift matrix for N first frequency touch signals such that a sum signal of the N first frequency touch signals having a first frequency has equal power in N/m code symbols among N code symbols and is canceled out in remaining (N−N/m) code symbols among the N code symbols, determining the first frequency touch signals by applying the first phase shift matrix to the orthogonal codes, determining a k-th phase shift matrix for N k-th frequency touch signals having a k-th frequency by shifting the first phase shift matrix, and determining the k-th frequency touch signals by applying the k-th phase shift matrix to the orthogonal codes.

### CROSS-REFERENCE TO RELATED APPLICATION(S)

This application claims priority to and the benefits of Korean Patent Application No. 10-2024-0175219 under 35 USC § 119, filed on Nov. 29, 2024, in the Korean Intellectual Property Office (KIPO), the entire contents of which are incorporated herein by reference.

### BACKGROUND

### 1. Technical Field

Embodiments relate to a method of determining touch signals for a touch sensor included in a display device, the display device using the touch signals, and an electronic device including the display device.

### 2. Description of the Related Art

A display device may detect a change in capacitance between touch transmission electrodes and touch reception electrodes by applying touch signals to the touch transmission electrodes of a touch sensor and by receiving the touch signals through the touch reception electrodes of the touch sensor, and may sense a presence and a position of a touch based on the change in capacitance. To perform this operation, a touch controller of a conventional display device may sequentially apply the touch signals to the touch transmission electrodes in a time division driving method. However, as a size of a display panel increases, a size of the touch sensor on the display panel increases, a touch frame rate increases, and the touch sensitivity and the accuracy of the time division driving method may be decreased.

In order to improve the touch sensitivity and the accuracy, a frequency division driving method (or a multi-frequency driving method) that simultaneously applies the touch signals to the touch transmission electrodes using different frequencies, a code division driving method (or a multi-code driving method) that simultaneously applies the touch signals to the touch transmission electrodes using orthogonal frequencies, etc. have been developed. However, in these driving methods, since the touch signals are overlapped or accumulated, a peak to average power ratio (“PAPR”) of a sum signal of the touch signals may be increased. Further, if the PAPR increases, a precision of an analog-to-digital converting operation may be decreased, and a signal distortion may occur.

### SUMMARY

Embodiments provide a method of determining touch signals for a touch sensor capable of increasing a peak to average power ratio (“PAPR”) of a sum signal of the touch signals.

Embodiments provide a display device using the touch signals.

Embodiments provide an electronic device including the display device.

According to embodiments, a method of determining N×m touch signals for a touch sensor including N×m touch transmission electrodes, where each of N and m may be an integer greater than or equal to 2, may include generating an orthogonal matrix including N orthogonal codes, determining a first phase shift matrix for N first frequency touch signals such that a sum signal of the N first frequency touch signals having a first frequency has equal power in N/m code symbols among N code symbols and is canceled out in remaining (N−N/m) code symbols among the N code symbols, determining the N first frequency touch signals by applying the first phase shift matrix to the N orthogonal codes, determining a k-th phase shift matrix for N k-th frequency touch signals having a k-th frequency by shifting the first phase shift matrix, where k may be an integer greater than or equal to 2 and less than or equal to m, and determining the N k-th frequency touch signals by applying the k-th phase shift matrix to the N orthogonal codes.

In embodiments, a sum signal of the N k-th frequency touch signals may have equal power in N/m other code symbols among the remaining (N−N/m) code symbols where the sum signal of the N first frequency touch signals is canceled out, and may be canceled out in other remaining (N−N/m) code symbols excluding the N/m other code symbols among the N code symbols.

In embodiments, the orthogonal matrix may be an N×N Hadamard matrix.

In embodiments, the first phase shift matrix may be determined by Equation 1. “

$$Frequency separation {phase}_{Hadamard}^{1} ( N , m ) = Frequency separation {phase}_{Hadamard} ( \frac{N}{m} ) * m \qquad [ Equation 1 ]$$

In Equation 1,

$$Frequency separation {phase}_{Hadamard}^{1} ( N , m )$$

may be the first phase shift matrix,

$$Frequency separation {phase}_{Hadamard} ( \frac{N}{m} )$$

may be a power distribution matrix for an (N/m)×(N/m) Hadamard matrix, and

$$Frequency separation {phase}_{Hadamard} ( \frac{N}{m} ) * m$$

may be obtained by concatenating the power distribution matrix m times.

In embodiments, in case that N/m is 2\hat{ }p and p is 2q, where p may be an integer greater than or equal to 1 and q may be an integer greater than or equal to 0, the power distribution matrix may be determined by Equation 2.

$$Frequency seperation {phase}_{Hadamard} ( {2}^{p} ) = Hadamard ( {2}^{q} ) \qquad [ Equation 2 ]$$

In case that N/m is 2\hat{ }p and p is 2q+1, the power distribution matrix may be determined by Equation 3.

$$Frequency seperation {phase}_{Hadamard} ( {2}^{p} ) = Hadamard ( {2}^{q} ) + i \times Hadamard ( {2}^{q} ) \qquad [ Equation 3 ]$$

In Equations 2 and 3, Frequency separation phase_{Hadamard}(2^{p}) may be the power distribution matrix, Hadamard(2^{q}) may be a (2\hat{ }q)×(2\hat{ }q) Hadamard matrix, and i may represent a unit imaginary number.

In embodiments, the k-th phase shift matrix may be determined by Equation 4.

$$Frequency separation {phase}_{Hadamard}^{k} ( N , m ) = Frequency separation {phase}_{Hadamard}^{1} ( N , m ) ∘ {Hadamard ( N )}_{\frac{N}{m} ( k - 1 ) + 1} \qquad [ Equation 4 ]$$

In Equation 4,

$$Frequency separation {phase}_{Hadamard}^{k} ( N , m )$$

may be the k-th phase shift matrix,

$$Frequency separation {phase}_{Hadamard}^{1} ( N , m )$$

may be the first phase shift matrix,

$${Hadamard ( N )}_{\frac{N}{m} ( k - 1 ) + 1}$$

may represent a

$$\frac{N}{m} ( k - 1 ) + 1$$

-th row of an N×N Hadamard matrix, and an operator ‘∘’ may represent a Hadamard product.

In embodiments, the orthogonal matrix may be an N×N Fourier matrix.

In embodiments, the first phase shift matrix may be determined by Equation 5.

$$Frequency separation {phase}_{Fourier}^{1} ( N , m ) = Frequency separation {phase}_{Fourier} ( \frac{N}{m} ) * m \qquad [ Equation 5 ]$$

In Equation 5,

$$Frequency separation {phase}_{Fourier}^{1} ( N , m )$$

may be the first phase shift matrix, matrix,

$$Frequency separation {phase}_{Fourier} ( \frac{N}{m} )$$

may be a power distribution matrix for an (N/m)×(N/m) Fourier matrix, and

$$Frequency separation {phase}_{Fourier} ( \frac{N}{m} ) * m$$

may be obtained by concatenating the power distribution matrix m times.

In embodiments, the method may further include generating a P×P Fourier matrix, P being an integer of N/m, generating a 1×P phase shift matrix including P phase shift values for P rows of the P×P Fourier matrix, generating a phase-shifted matrix by performing matrix multiplication of the 1×P phase shift matrix and the P×P Fourier matrix, and determining the power distribution matrix as the 1×P phase shift matrix that allows respective elements of the phase-shifted matrix to have a same absolute value.

In embodiments, the k-th phase shift matrix may be determined by Equation 6.

$$Frequency separation {phase}_{Fourier}^{k} ( N , m ) = Frequency separation {phase}_{Fourier}^{1} ( N , m ) ∘ {Fourier ( N )}_{k} \qquad [ Equation 6 ]$$

In Equation 6,

$$Frequency separation {phase}_{Fourier}^{k} ( N , m )$$

may be the k-th phase shift matrix,

$$Frequency separation {phase}_{Fourier}^{1} ( N , m )$$

may be the first phase shift matrix, Fourier(N)ₖ may represent a k-th row of an N×N Fourier matrix, and an operator ‘∘’ may represent a Hadamard product.

According to embodiments, a display device may include a display panel including a plurality of pixels, a touch sensor including N×m touch transmission electrodes, where each of N and m may be an integer greater than or equal to 2, a display driver that drives the plurality of pixels, and a touch controller that drives the touch sensor. The touch controller may include a transmission processing circuit that stores an orthogonal matrix including N orthogonal codes, and first through m-th phase shift matrices respectively associated with first through m-th frequencies, and generates N×m phase-shifted orthogonal codes by applying the first through m-th phase shift matrices to the N orthogonal codes, and N×m transmission channel circuits that respectively receive the N×m phase-shifted orthogonal codes from the transmission processing circuit, generate N×m touch signals based on the N×m phase-shifted orthogonal codes, and respectively transmit the N×m touch signals to the N×m touch transmission electrodes.

In embodiments, a sum signal of N first frequency touch signals among the N×m touch signals may have equal power in N/m code symbols among the N code symbols, and may be canceled out in remaining (N−N/m) code symbols among the N code symbols.

In embodiments, a sum signal of k-th frequency touch signals may have equal power in N/m other code symbols among the remaining (N−N/m) code symbols where the sum signal of the N first frequency touch signals is canceled out, and may be canceled out in other remaining (N−N/m) code symbols excluding the N/m other code symbols among the N code symbols, where k may be an integer greater than or equal to 2 and less than or equal to m.

In embodiments, the orthogonal matrix may be an N×N Hadamard matrix.

In embodiments, the first phase shift matrix may be determined by Equation 1.

$$Frequency separation {phase}_{Hadamard}^{1} ( N , m ) = Frequency separation {phase}_{Hadamard} ( \frac{N}{m} ) * m \qquad [ Equation 1 ]$$

In Equation 1,

$$Frequency separation {phase}_{Hadamard}^{1} ( N , m )$$

may be the first phase shift matrix,

$$Frequency separation {phase}_{Hadamard} ( \frac{N}{m} )$$

may be a power distribution matrix for an (N/m)×(N/m) Hadamard matrix, and

$$Frequency separation {phase}_{Hadamard} ( \frac{N}{m} ) * m$$

may be obtained by concatenating the power distribution matrix m times.

In embodiments, the orthogonal matrix may be an N×N Fourier matrix.

In embodiments, the first phase shift matrix may be determined by Equation 5.

$$Frequency separation {phase}_{Fourier}^{1} ( N , m ) = Frequency separation {phase}_{Fourier} ( \frac{N}{m} ) * m \qquad [ Equation 5 ]$$

In Equation 5,

$$Frequency separation {phase}_{Fourier}^{1} ( N , m )$$

may be the first phase shift matrix,

$$Frequency separation {phase}_{Fourier} ( \frac{N}{m} )$$

may be a power distribution matrix for an (N/m)×(N/m) Fourier matrix, and

$$Frequency separation {phase}_{Fourier} ( \frac{N}{m} ) * m$$

may be obtained by concatenating the power distribution matrix m times.

In embodiments, the touch sensor may further include a plurality of touch reception electrodes. The touch controller may further include a plurality of reception channel circuits connected to the plurality of touch reception electrodes, respectively, each of the plurality of reception channel circuits receiving a sum signal of the N×m touch signals through a corresponding one of the plurality of touch reception electrodes, and generating sum signal data by performing an analog-to-digital converting operation on the sum signal, and a reception processing circuit that receives the sum signal data from the each of the plurality of reception channel circuits, and generates touch signal data for the N×m touch signals by performing a decoding operation on the sum signal data.

According to embodiments, an electronic device may include a processor, a memory connected to the processor, a power module connected to the processor, and a display device that receives input image data from the processor, and displays an image based on the input image data. The display device may include a display panel including a plurality of pixels, a touch sensor including N×m touch transmission electrodes, where each of N and m may be an integer greater than or equal to 2, a display driver that drives the plurality of pixels, and a touch controller that drives the touch sensor. The touch controller may include a transmission processing circuit that stores an orthogonal matrix including N orthogonal codes, and first through m-th phase shift matrices respectively associated with first through m-th frequencies, and generates N×m phase-shifted orthogonal codes by applying the first through m-th phase shift matrices to the N orthogonal codes, and N×m transmission channel circuits that respectively receive the N×m phase-shifted orthogonal codes from the transmission processing circuit, generate N×m touch signals based on the N×m phase-shifted orthogonal codes, and respectively transmit the N×m touch signals to the N×m touch transmission electrodes.

In embodiments, a sum signal of N first frequency touch signals among the N×m touch signals may have equal power in N/m code symbols among the N code symbols, and may be canceled out in remaining (N−N/m) code symbols among the N code symbols. A sum signal of k-th frequency touch signals may have equal power in N/m other code symbols among the remaining (N−N/m) code symbols where the sum signal of the N first frequency touch signals is canceled out, and may be canceled out in other remaining (N−N/m) code symbols excluding the N/m other code symbols among the N code symbols, where k is an integer greater than or equal to 2 and less than or equal to m.

As described above, in a method of determining touch signals using N orthogonal codes and m frequencies, a display device and an electronic device according to embodiments, where N may be an integer greater than or equal to 2 and m may be an integer greater than or equal to 2, a sum signal of the touch signals having a same frequency among the m frequencies may have equal power in N/m code symbols among N code symbols, and may be canceled out in the remaining (N−N/m) code symbols among the N code symbols. Further, sum signals of the touch signals having different frequencies may have equal power in different code symbols. Accordingly, a PAPR of the sum signal of the touch signals may be reduced.

### BRIEF DESCRIPTION OF THE DRAWINGS

Illustrative, non-limiting embodiments will be more clearly understood from the following detailed description in conjunction with the accompanying drawings.

FIG. 1 is a flow chart illustrating a method of determining touch signals according to embodiments.

FIG. 2 is a flow chart illustrating a method of determining touch signals using a Hadamard matrix according to embodiments.

FIG. 3 is an example of an 8×8 Hadamard matrix.

FIG. 4 is equations for determining a first phase shift matrix for first frequency touch signals.

FIG. 5 is an example of equations for determining a first phase shift matrix for first frequency touch signals in case that eight orthogonal codes and four frequencies are used.

FIG. 6 is an example of a sum of orthogonal codes to which a first phase shift matrix is applied.

FIG. 7 is a schematic timing diagram illustrating an example of first frequency touch signals and a sum signal of the first frequency touch signals.

FIG. 8 is an equation for determining a k-th phase shift matrix by shifting a first phase shift matrix.

FIG. 9 is an example of an equation for determining a second phase shift matrix by shifting a first phase shift matrix in case that eight orthogonal codes and four frequencies are used.

FIG. 10 is an example of a sum of orthogonal codes to which a second phase shift matrix is applied.

FIG. 11 is a schematic timing diagram illustrating an example of second frequency touch signals and a sum signal of the second frequency touch signals.

FIG. 12 is a schematic timing diagram illustrating an example of a sum signal of thirty two touch signals in case that eight orthogonal codes and four frequencies are used.

FIG. 13 is a graph showing cumulative distributions of PAPRs of sum signals of touch signals in case that a phase is not shifted, in case that the phase is shifted in a random manner, in case that the phase is shifted in a stack manner, and in case that the phase is shifted by a method of FIG. 2.

FIG. 14 is a flowchart illustrating a method for determining a touch signal using a Fourier matrix according to embodiments.

FIG. 15 is an example of an N×N Fourier matrix.

FIG. 16 is an equation for determining a first phase shift matrix for first frequency touch signals.

FIG. 17 is a flowchart illustrating a method for determining a power distribution matrix for an (N/m)×(N/m) Fourier matrix.

FIG. 18A is an equation for generating a phase-shifted matrix, and FIG. 18B is an equation for determining a power distribution matrix.

FIG. 19 is an example of a sum of orthogonal codes to which a first phase shift matrix is applied.

FIG. 20 is a schematic timing diagram illustrating an example of first frequency touch signals and a sum signal of the first frequency touch signals.

FIG. 21 is an equation for determining a k-th phase shift matrix by shifting a first phase shift matrix.

FIG. 22 is a schematic timing diagram illustrating an example of a sum signal of eighteen touch signals in case that six orthogonal codes and three frequencies are used.

FIG. 23 is graph showing cumulative distributions of PAPRs of sum signals of touch signals in case that a phase is not shifted, in case that the phase is shifted in a random manner, in case that the phase is shifted in a stack manner, and in case that the phase is shifted by a method of FIG. 14.

FIG. 24 is a schematic block diagram illustrating a display device according to embodiments.

FIG. 25 is a schematic diagram illustrating a touch sensor included in a display device according to embodiments.

FIG. 26 is a schematic diagram illustrating a touch controller included in a display device according to embodiments.

FIG. 27 is a schematic block diagram illustrating an electronic device according to embodiments.

FIG. 28 is a schematic diagram of an electronic device according to various embodiments.

### DETAILED DESCRIPTION OF THE EMBODIMENTS

Hereinafter, embodiments of the disclosure will be explained in detail with reference to the accompanying drawings. The same reference numerals are used for the same components in the drawings, and duplicate descriptions of the same components are omitted.

The term “about” may include variations of, for example, ±20%, ±10%, or ±5%, from the specified numerical value unless otherwise expressly stated. In some contexts, the term may account for rounding, inherent measurement limitations, or standard tolerances recognized in the relevant technical field. When applied to dimensions, concentrations, or other quantifiable parameters, “about” may include minor deviations that would be understood by a person of ordinary skill in the art as insubstantial in the given context. The scope of “about” should be interpreted in view of standard experimental or clinical tolerances applicable to the field of use. A person skilled in the art would recognize that “about” allows for practical deviations that do not materially alter the intended properties of the invention. Similarly, for mechanical dimensions, “about” may include deviations that are within industry-accepted tolerances and do not materially impact the performance of the disclosure.

In the specification and the claims, the phrase “at least one of” is intended to include the meaning of “at least one selected from the group of” for the purpose of its meaning and interpretation. For example, “at least one of A and B” may be understood to mean “A, B, or A and B.” In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

Unless otherwise defined or implied herein, all terms (including technical and scientific terms) used have the same meaning as commonly understood by those skilled in the art to which this disclosure pertains. It will be further understood that terms, such as those defined in commonly used dictionaries, should be interpreted as having a meaning that is consistent with their meaning in the context of the relevant art and should not be interpreted in an ideal or excessively formal sense unless clearly defined in the specification.

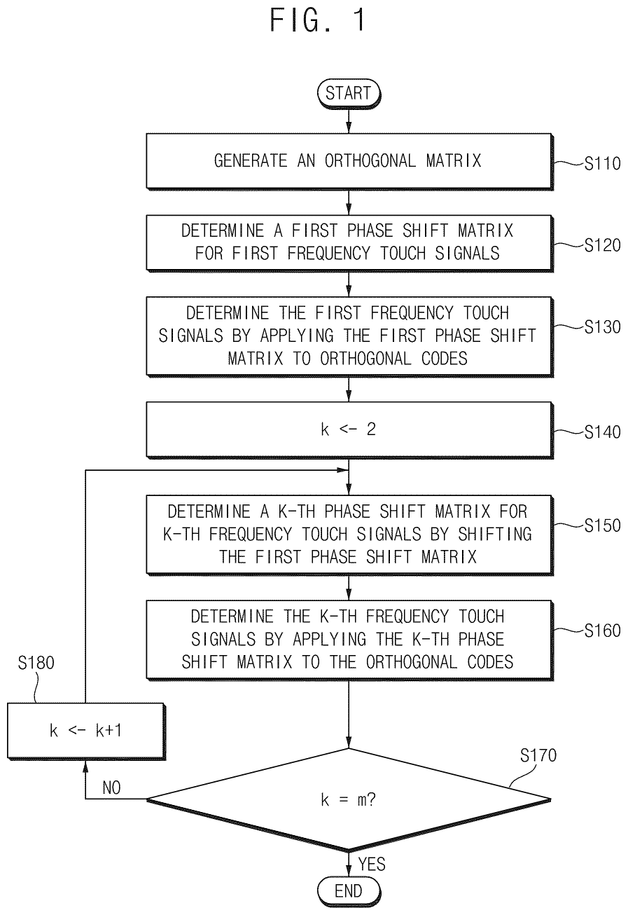

FIG. 1 is a flow chart illustrating a method of determining touch signals according to embodiments.

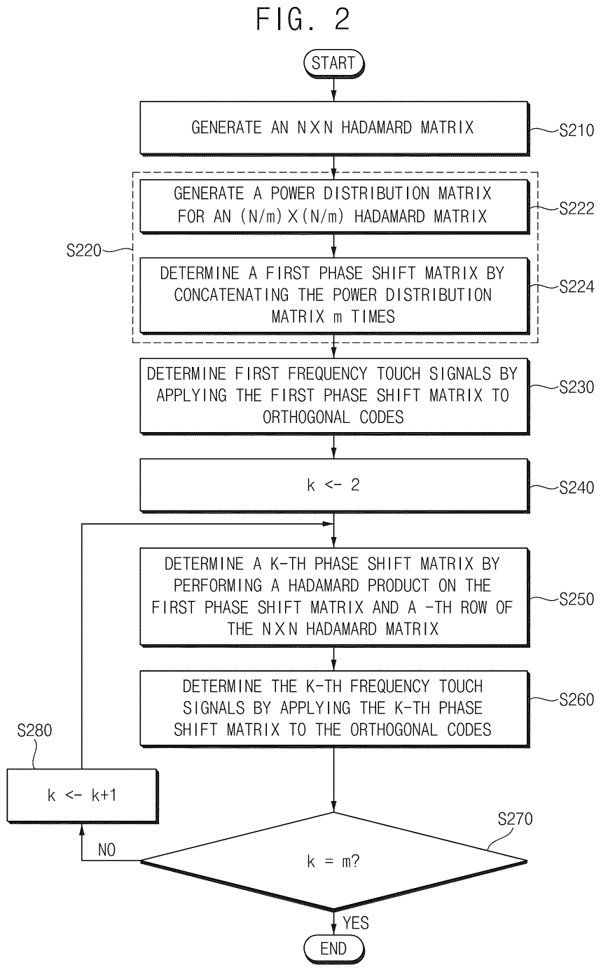

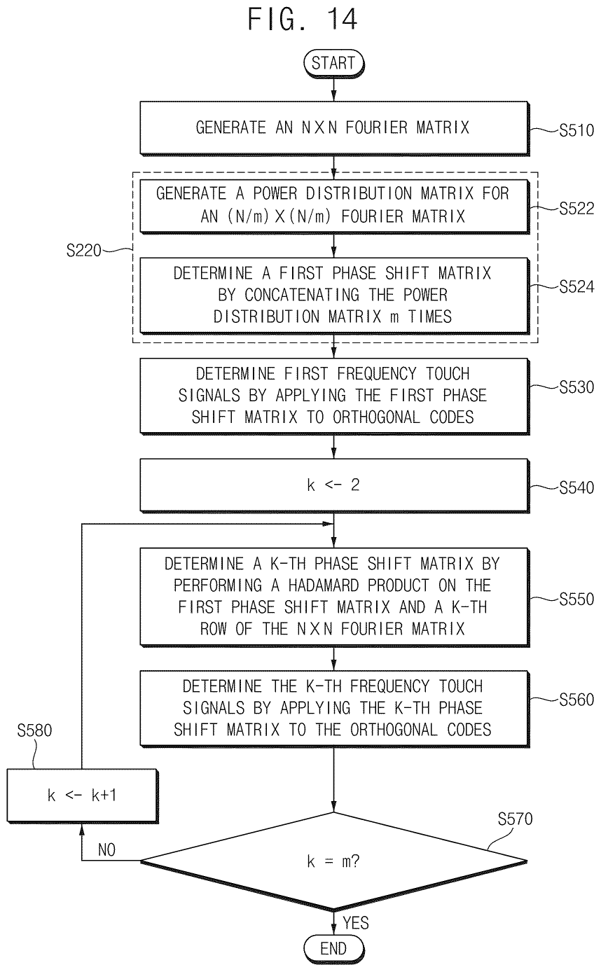

Referring to FIG. 1, in a method of determining N×m touch signals using N orthogonal codes and m frequencies according to embodiments, where N may be an integer greater than or equal to 2 and m may be an integer greater than or equal to 2, an orthogonal matrix including N rows that are the N orthogonal codes may be generated (S110). In some embodiments, as described below with reference to FIGS. 2 through 13, the orthogonal matrix may be an N×N Hadamard matrix having N rows and N columns. In other embodiments, as described below with reference to FIGS. 14 through 23, the orthogonal matrix may be an N×N Fourier matrix having N rows and N columns. The orthogonal codes may be codes that are orthogonal to each other. For example, an operation for different orthogonal codes may have a result of 0, and thus touch signals having a same frequency among the m frequencies may be distinguished from each other using the orthogonal codes. Further, the N×m touch signals may be signals applied to the N×m touch transmission electrodes of the touch sensor, respectively. The N×m touch signals may include N first-frequency touch signals having a first frequency, and N k-th frequency touch signals having a k-th frequency, where k may be an integer greater than or equal to 2 and less than or equal to m.

A first phase shift matrix representing phase shift values for the first frequency touch signals may be determined such that a sum signal of the first frequency touch signals having the first frequency may have equal power in N/m code symbols (or N/m periods) among N code symbols (or N periods into which a touch frame period is divided) and may be canceled out in the remaining (N−N/m) code symbols (or the remaining (N−N/m) periods) among the N code symbols (S120), and the first frequency touch signals may be determined by applying the first phase shift matrix to the orthogonal codes (S130). Accordingly, in case that the N orthogonal codes and the m frequencies are used, the sum signal of the first frequency touch signals having the first frequency may have equal power in the N/m code symbols or the N/m periods, and may be canceled out in the remaining (N−N/m) code symbols or the remaining (N−N/m) periods.

A second phase shift matrix representing phase shift values for N second frequency touch signals having a second frequency may be determined by shifting the first phase shift matrix (S140 and S150), and the second frequency touch signals may be determined by applying the second phase shift matrix to the orthogonal codes (S160). In some embodiments, the second phase shift matrix may be determined such that a sum signal of the second frequency touch signals may have equal power in N/m other code symbols among the remaining (N−N/m) code symbols where the sum signal of the first frequency touch signals is canceled out, and may be canceled in remaining (N−N/m) code symbols excluding the N/m other code symbols among the N code symbols.

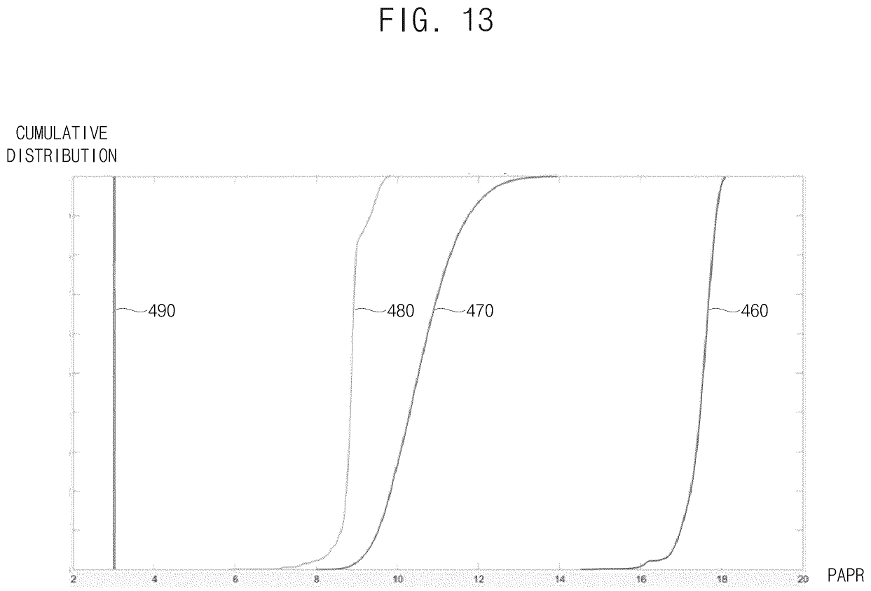

Determining a k-th phase shift matrix using the first phase shift matrix (S150), where k is an integer greater than or equal to 2 and less than or equal to m, and determining the k-th frequency touch signals having the k-th frequency by applying the k-th phase shift matrix to the orthogonal codes (S160) may be performed until m-th frequency touch signals having an m-th frequency are determined (S170 and S180). Thus, a sum signal of the touch signals having a same frequency among the m frequencies may have equal power in N/m code symbols or N/m periods, and may be canceled out in remaining (N−N/m) code symbols or remaining (N−N/m) periods. Further, the sum signals associated with different frequencies may have equal power in different code symbols or different periods. Accordingly, as described below with reference to FIG. 12 or FIG. 22, the N code symbols or the N periods may be distinguished by frequency.

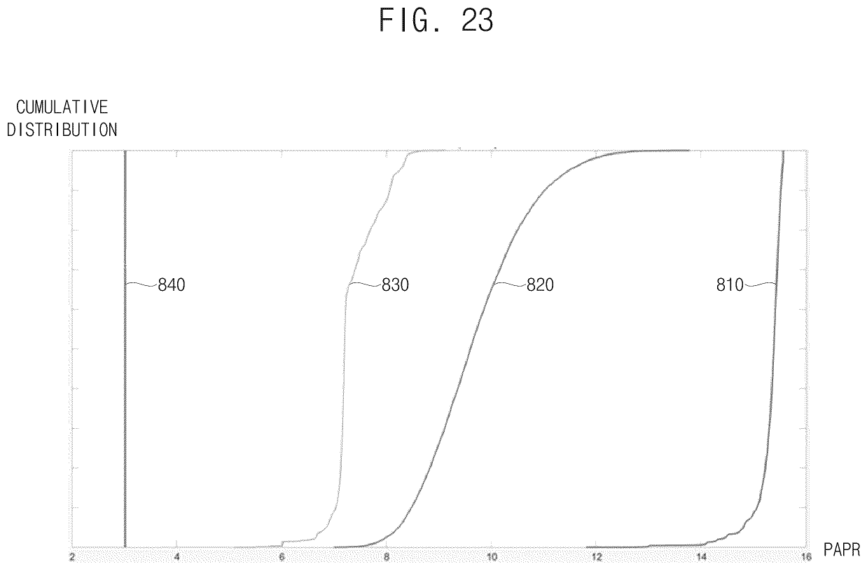

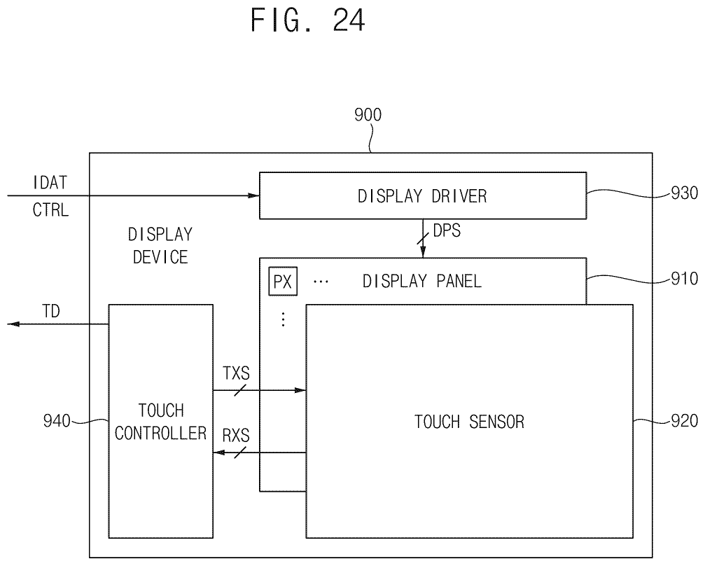

As described above, in the method of determining the touch signals according to embodiments, the N×m touch signals using the N orthogonal codes and the m frequencies may be determined such that the sum signal of the touch signals having a same frequency may have equal power in N/m code symbols (or N/m periods), the sum signal of the touch signals having a same frequency may be canceled out in the remaining (N−N/m) code symbols (or the remaining (N−N/m) periods), and the sum signals associated with different frequencies may have equal power in different code symbols or different periods. Accordingly, as illustrated in FIG. 13 or FIG. 23, a peak to average power ratio (“PAPR”) of a sum signal of the N×m touch signals may be reduced.

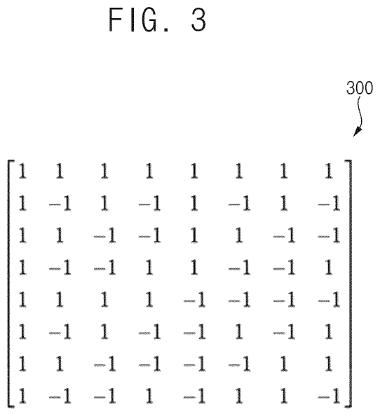

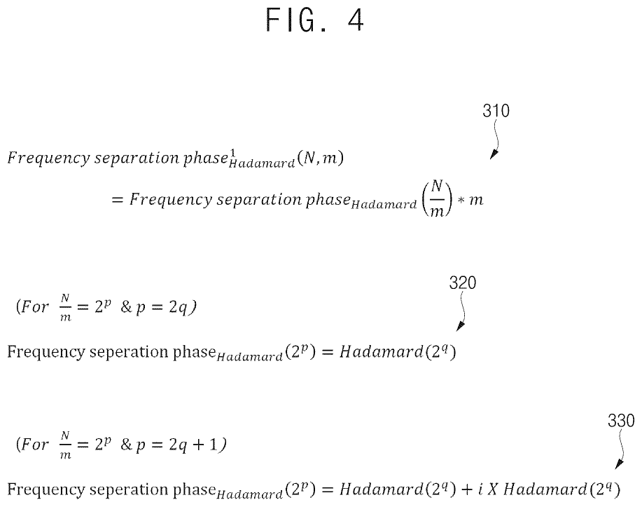

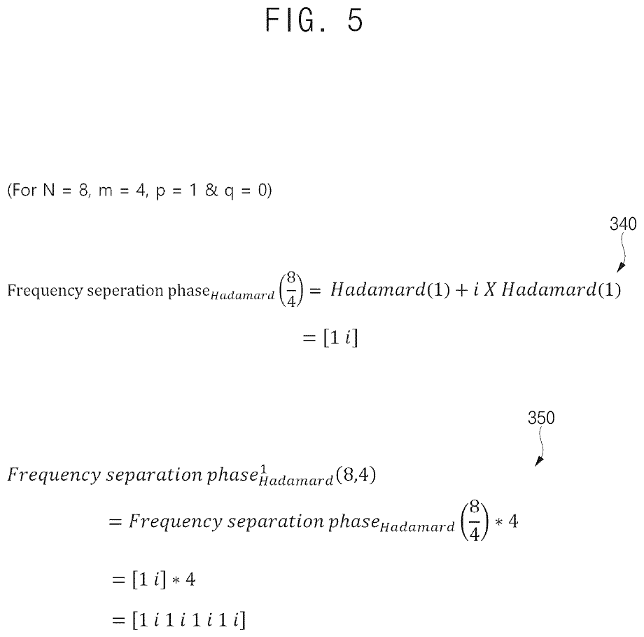

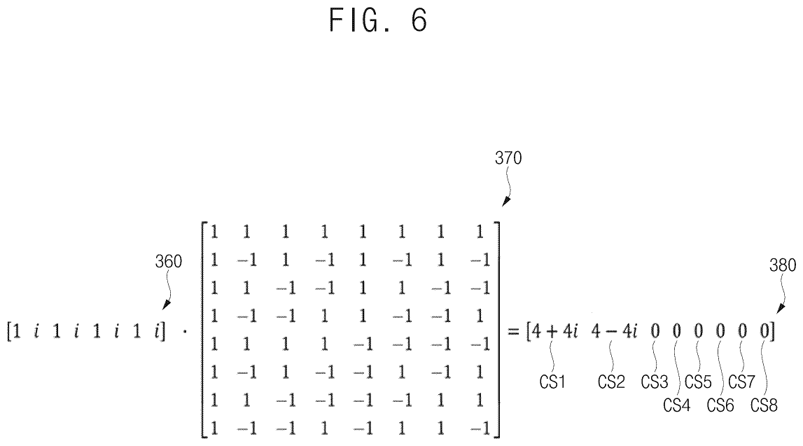

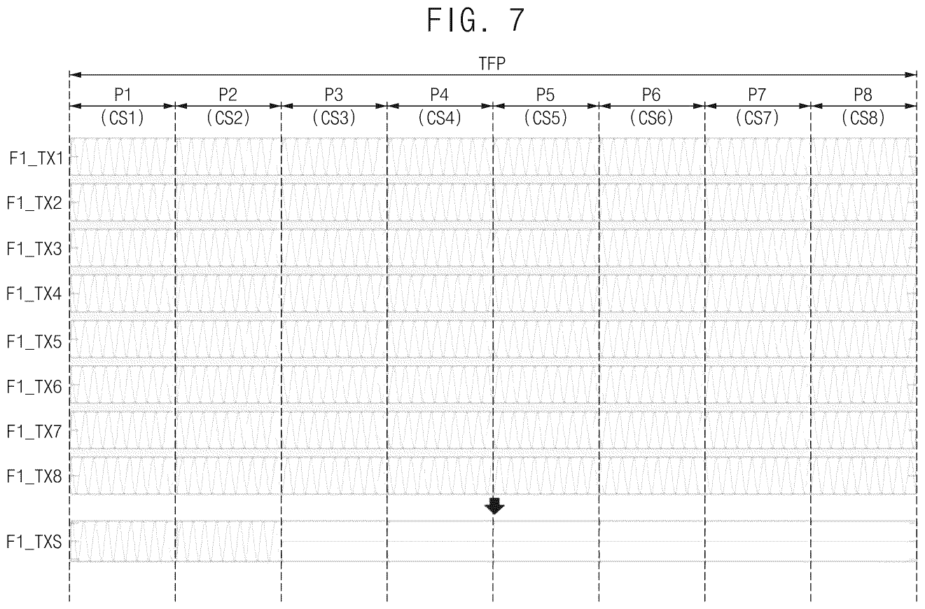

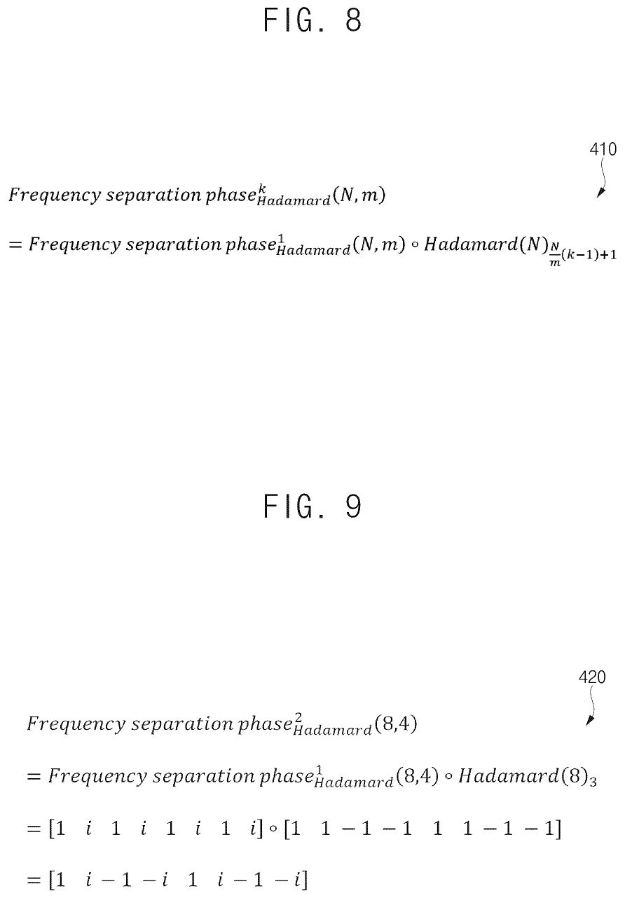

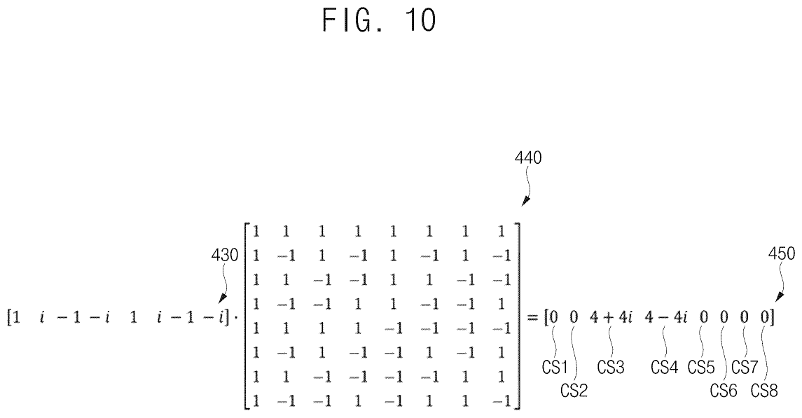

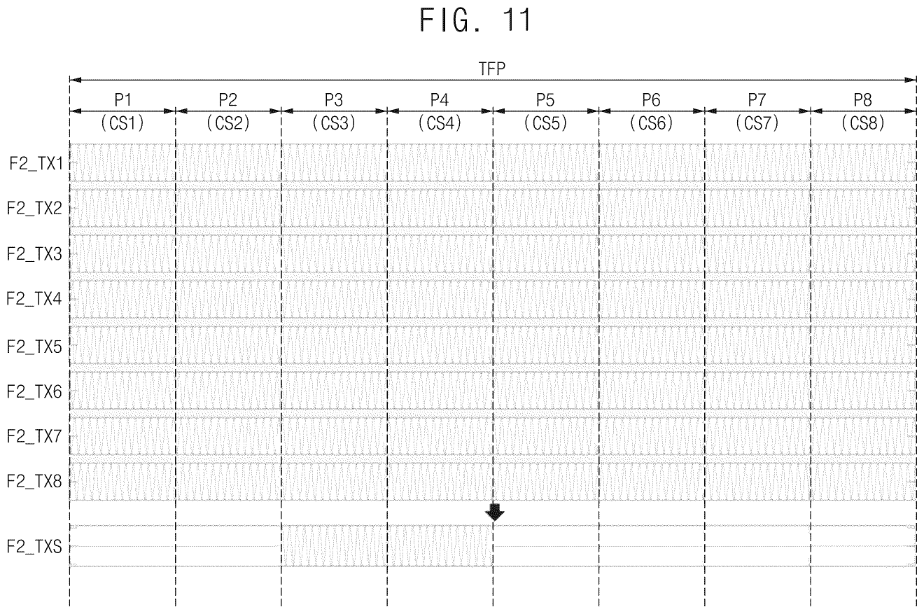

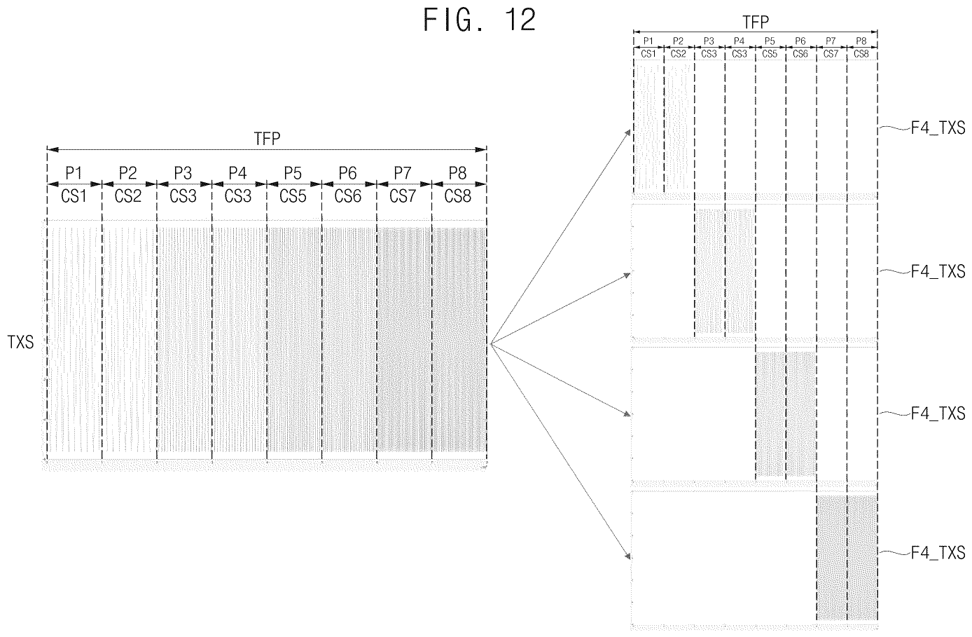

FIG. 2 is a flow chart illustrating a method of determining touch signals using a Hadamard matrix according to embodiments, FIG. 3 is an example of an 8×8 Hadamard matrix, FIG. 4 is equations for determining a first phase shift matrix for first frequency touch signals, FIG. 5 is an example of equations for determining a first phase shift matrix for first frequency touch signals in case that eight orthogonal codes and four frequencies are used, FIG. 6 is an example of a sum of orthogonal codes to which a first phase shift matrix is applied, FIG. 7 is a schematic timing diagram illustrating an example of first frequency touch signals and a sum signal of the first frequency touch signals, FIG. 8 is an equation for determining a k-th phase shift matrix by shifting a first phase shift matrix, FIG. 9 is an example of an equation for determining a second phase shift matrix by shifting a first phase shift matrix in case that eight orthogonal codes and four frequencies are used, FIG. 10 is an example of a sum of orthogonal codes to which a second phase shift matrix is applied, FIG. 11 is a schematic timing diagram illustrating an example of second frequency touch signals and a sum signal of the second frequency touch signals, and FIG. 12 is a schematic timing diagram illustrating an example of a sum signal of thirty two touch signals in case that eight orthogonal codes and four frequencies are used.

Referring to FIG. 2, in a method of determining N×m touch signals using N orthogonal codes and m frequencies according to embodiments, where N may be an integer greater than or equal to 2 and m may be an integer greater than or equal to 2, an N×N Hadamard matrix including N rows and N columns may be generated (S210). The N rows of N×N Hadamard matrix may be the N orthogonal codes. For example, in case that thirty two touch signals are determined by using eight orthogonal codes and four frequencies, as illustrated in FIG. 3, an 8×8 Hadamard matrix 300 may be generated. Here, eight rows of the 8×8 Hadamard matrix 300 may be used as the eight orthogonal codes. For example, a first orthogonal code may be “[1 1 1 1 1 1 1 1]”, a second orthogonal code may be “[1 −1 1 −1 1 −1 1 −1]”, a third orthogonal code may be “[1 1 −1 −1 1 1 −1 −1]”, a fourth orthogonal code may be “[1 −1 −1 1 1 −1 −1 1]”, a fifth orthogonal code may be “[1 1 1 1 −1 −1 −1 −1]”, a sixth orthogonal code may be “[1 −1 1 −1 −1 1 −1 1]”, a seventh orthogonal code may be “[1 1 −1 −1 −1 −1 1 1]”, and an eighth orthogonal code may be “[1 −1 −1 1 −1 1 1 −1]”.

A first phase shift matrix representing phase shift values for first frequency touch signals having a first frequency among the N×m touch signals may be determined (S220). The first phase shift matrix may be determined such that a sum signal of the first frequency touch signals has equal power in N/m code symbols (or N/m periods) among the N code symbols (or N periods into which a touch frame period is divided) and is canceled out in the remaining (N−N/m) code symbols (or the remaining (N−N/m) periods) among the N code symbols (or the N/m periods). In some embodiments, a power distribution matrix for an (N/m)×(N/m) Hadamard matrix may be generated (S222), and the first phase shift matrix may be determined by concatenating the power distribution matrix m times (S224).

For example, as illustrated in FIG. 4, the first phase shift matrix may be determined by Equation 310.

$$Frequency separation {phase}_{Hadamard}^{1} ( N , m ) = Frequency separation {phase}_{Hadamard} ( \frac{N}{m} ) * m \qquad [ Equation 310 ]$$

In Equation 310,

$$Frequency separation {phase}_{Hadamard}^{1} ( N , m )$$

may be the first phase shift matrix,

$$Frequency separation {phase}_{Hadamard} ( \frac{N}{m} )$$

may be the power distribution matrix for the (N/m)×(N/m) Hadamard matrix, and

$$Frequency separation {phase}_{Hadamard} ( \frac{N}{m} ) * m$$

may be obtained by concatenating the power distribution matrix m times. In case that N/m is 2\hat{ }p and p is 2q, p is an integer greater than or equal to 1 and q is an integer greater than or equal to 0, the power distribution matrix may be determined based on Equation 320.

$$Frequency seperation {phase}_{Hadamard} ( {2}^{p} ) = Hadamard ( {2}^{q} ) \qquad [ Equation 320 ]$$

Further, in case that N/m is 2\hat{ }p and p is 2q+1, the power distribution matrix may be determined based on Equation 330.

$$Frequency seperation {phase}_{Hadamard} ( {2}^{p} ) = Hadamard ( {2}^{q} ) + i \times Hadamard ( {2}^{q} ) ” . \qquad [ Equation 330 ]$$

In Equations 320 and 330, Frequency separation phase_{Hadamard}(2^{p}) may be the power distribution matrix, Hadamard(2^{q}) may be a (2\hat{ }q)×(2\hat{ }q) Hadamard matrix, and i may represent a unit imaginary number. In case that N/m is not 2\hat{ }p, the touch signals may be determined using a Fourier matrix instead of the Hadamard matrix as described below with reference to FIGS. 14 through 23.

For example, in case that eight orthogonal codes and four frequencies are used, or in case that N is 8, m is 4, p is 1 and q is 0, as illustrated in FIG. 5, since p is 2q+1, the power distribution matrix for the (8/4)×(8/4) Hadamard matrix may be determined by the Equation 330 of FIG. 4 or the Equation 340 of FIG. 5.

$$Frequency seperation {phase}_{Hadamard} ( \frac{8}{4} ) = Hadamard ( 1 ) + i \times Hadamard ( 1 ) \qquad [ Equation 340 ]$$

In Equation 330 and 340, Hadamard(1) may be a 1×1 Hadamard matrix, or “[1]”, and an operator ‘+’ may be an operator that connects or appends two matrices. Thus, the power distribution matrix may be “[1 i]”. Further, the first phase shift matrix may be determined by the Equation 310 of FIG. 4 or the Equation 350 of FIG. 5.

$$Frequency seperation {phase}_{Hadamard}^{1} ( 8 , 4 ) = Frequency seperation {phase}_{Hadamard} ( \frac{8}{4} ) * 4 \qquad [ Equation 350 ]$$

Since the power distribution matrix is “[1 i]”, the first phase shift matrix may be determined as “[1 i 1 i 1 i 1 i]” by connecting “[1 i]” four times.

The first frequency touch signals may be determined by applying the first phase shift matrix to the orthogonal codes (S230). In some embodiments, elements of the first phase shift matrix may be respectively multiplied by the orthogonal codes to generate phase-shifted orthogonal codes, and the first frequency touch signals may be generated based on the phase-shifted orthogonal codes. For example, each element of the first phase shift matrix may have a value of “1” indicating a phase of about 0 degree, a value of “i” indicating a phase of about 90 degrees, a value of “−1” indicating a phase of about 180 degrees, or a value of “−i” indicating a phase of about 270 degrees. Thus, a phase of each orthogonal code may not be shifted in case that the orthogonal code is multiplied by “1”, the phase of each orthogonal code may be shifted by about 90 degrees in case that the orthogonal code is multiplied by “i”, the phase of each orthogonal code may be shifted by about 180 degrees in case that the orthogonal code is multiplied by “−1”, and the phase of each orthogonal may be shifted by about 270 degrees in case that the orthogonal code is multiplied by “−i”.

For example, in case that eight orthogonal codes and four frequencies are used, the first frequency touch signals may be determined by applying the first phase shift matrix, or “[1 i 1 i 1 i 1 i]” to the eight orthogonal codes. For example, to determine the first frequency touch signals, the first, third, fifth and seventh orthogonal codes may be multiplied by “1”, and the second, fourth, sixth and eighth orthogonal codes may be multiplied by “i”. The sum signal of the first frequency touch signals determined in this way may have equal power in (8/4) code symbols, i.e., two code symbols, and may be canceled out in the remaining (8−8/4) code symbols, i.e., the remaining six code symbols.

In other words, as illustrated in FIG. 6, the matrix multiplication of the first phase shift matrix 360 and the 8×8 Hadamard matrix 370 including the eight orthogonal codes may correspond to the sum signal of the first frequency touch signals. Further, a result 380 of the matrix multiplication of the first phase shift matrix 360 and the 8×8 Hadamard matrix 370 may have a same absolute value in a first code symbol CS1 and a second code symbol CS2, and may have a value of 0 in a third code symbol CS3, a fourth code symbol CS4, a fifth code symbol CS5, a sixth code symbol CS6, a seventh code symbol CS7 and an eighth code symbol CS8. This may mean that the sum signal of the first frequency touch signals has equal power in the first and second code symbols CS1 and CS2, and is canceled out in the third through eighth code symbols CS3 through CS8.

FIG. 7 shows the first frequency touch signals F1_TX1, F1_TX2, F1_TX3, F1_TX4, F1_TX5, F1_TX6, F1_TX7 and F1_TX8 determined as described above, and the sum signal F1_TXS of the first frequency touch signals F1_TX1 through F1_TX8. As illustrated in FIG. 7, the touch frame period TFP may be divided into first, second, third, fourth, fifth, sixth, seventh and eighth periods P1, P2, P3, P4, P5, P6, P7 and P8 respectively corresponding to the first, second, third, fourth, fifth, sixth, seventh and eighth code symbols CS1, CS2, CS3, CS4, CS5, CS6, CS7 and CS8. Further, since the first orthogonal code is “[1 1 1 1 1 1 1 1]” and a first element of the first phase shift matrix 360 has a value of “1”, a first phase-shifted orthogonal code may be “[1 1 1 1 1 1 1 1 1]”. Thus, a first signal F1_TX1 of the first frequency touch signals generated based on the first phase-shifted orthogonal code may be a sine signal of which a phase is not shifted in each of the first through eighth periods P1 through P8. Further, since the second orthogonal code is “[1 −1 1 −1 1 −1 1 −1]” and a second element of the first phase shift matrix 360 has a value of “i”, a second phase-shifted orthogonal code may be “[i −i i −i i −i i −i]”. Thus, a second signal F1_TX2 of the first frequency touch signals generated based on the second phase-shifted orthogonal code may be a sine signal of which a phase is shifted by about 90 degrees in each of the first, third, fifth and seventh periods P1, P3, P5 and P7, and may be a sine signal of which the phase is shifted by about 270 degrees in each of the second, fourth, sixth and eighth periods P2, P4, P6 and P8. Further, a third signal F1_TX3 of the first frequency touch signals may be a sine signal of which a phase is not shifted in each of the first, second, fifth and sixth periods P1, P2, P5 and P6, and may be a sine signal of which a phase is shifted by about 180 degrees in each of the third, fourth, seventh and eighth periods P3, P4, P7 and P8. Further, a fourth signal F1_TX4 of the first frequency touch signals may be a sine signal of which a phase is shifted by about 90 degrees in each of the first, fourth, fifth and eighth periods P1, P4, P5 and P8, and may be a sine signal of which a phase is shifted by about 270 degrees in each of the second, third, sixth and seventh periods P2, P3, P6 and P7. Further, a fifth signal F1_TX5 of the first frequency touch signals may be a sine signal of which a phase is not shifted in each of the first, second, third and fourth periods P1, P2, P3 and P4, and may be a sine signal of which a phase is shifted by about 180 degrees in each of the fifth, sixth, seventh and eighth periods P5, P6, P7 and P8. Further, a sixth signal F1_TX6 of the first frequency touch signals may be a sine signal of which a phase is shifted by about 90 degrees in each of the first, third, sixth and eighth periods P1, P3, P6 and P8, and may be a sine signal of which a phase is shifted by about 270 degrees in each of the second, fourth, fifth and seventh periods P2, P4, P5 and P7. Further, a seventh signal F1_TX7 of the first frequency touch signals may be a sine signal of which a phase is not shifted in each of the first, second, seventh and eighth periods P1, P2, P7 and P8, and may be a sine signal of which a phase is shifted by about 180 degrees in each of the third, fourth, fifth and sixth periods P3, P4, P5 and P6. Further, an eighth signal F1_TX8 of the first frequency touch signals may be a sine signal of which a phase is shifted by about 90 degrees in each of the first, fourth, sixth and seventh periods P1, P4, P6 and P7, and may be a sine signal of which a phase is shifted by about 270 degrees in each of the second, third, fifth and eighth periods P2, P3, P5 and P8. Accordingly, the sum signal F1_TXS of the first frequency touch signals may be a signal obtained by summing four sine signals of which phases are not shifted and four sine signals of which phases are shifted by about 90 degrees in the first period P1, and a signal obtained by summing four sine signals of which phases are not shifted and four sine signals of which phases are shifted by about 270 degrees in the second period P2. Thus, the sum signal F1_TXS of the first frequency touch signals may have a same absolute value in the first period P1 and the second period P2, and may have equal power in the first period P1 and the second period P2. Further, in each of the third through eighth periods P3 through P8, the sum signal F1_TXS of the first frequency touch signals may be a signal obtained by summing two sine signals of which phases are not shifted, two sine signals of which phases are shifted by about 90 degrees, two sine signals of which phases are shifted by about 180 degrees, and two sine signals of which phases are shifted by about 270 degrees. Thus, in each of the third through eighth periods P3 through P8, the sum signal F1_TXS of the first frequency touch signals may be a signal having amplitude of about 0, and the first frequency touch signals F1_TX1 through F1_TX8 may be canceled out.

Referring again to FIG. 2, a k-th phase shift matrix may be determined by shifting the first phase shift matrix, where k may be an integer greater than or equal to 2 and less than or equal to m (S250), and k-th frequency touch signals having a k-th frequency may be determined by applying the k-th phase shift matrix to the orthogonal codes (S260). In some embodiments, the k-th phase shift matrix may be determined by performing a Hadamard product (or an element-wise product) on the first phase shift matrix and a

$$\frac{N}{m} ( k - 1 ) + 1$$

-th row of the N×N Hadamard matrix. For example, as shown in FIG. 8, the k-th phase shift matrix may be determined by Equation 410.

$$Frequency separation {phase}_{Hadamard}^{k} ( N , m ) = Frequency separation {phase}_{Hadamard}^{1} ( N , m ) ∘ {Hadamard ( N )}_{\frac{N}{m} ( k - 1 ) + 1} \qquad [ Equation 410 ]$$

In Equation 410,

$$Frequency separation {phase}_{Hadamard}^{k} ( N , m )$$

may be the k-th phase shift matrix,

$$Frequency separation {phase}_{Hadamard}^{1} ( N , m )$$

may be the first phase shift matrix,

$${Hadamard ( N )}_{\frac{N}{m} ( k - 1 ) + 1}$$

may represent the

$$\frac{N}{m} ( k - 1 ) + 1$$

-th row of the N×N Hadamard matrix, and the operator ‘∘’ may represent the Hadamard product. Determining the k-th phase shift matrix and determining the k-th frequency touch signals may be repeatedly performed until second frequency touch signals through m-th frequency touch signals are determined (S240, S250, S260, S270 and S280).

For example, in case that eight orthogonal codes and four frequencies are used, a second phase shift matrix for the second frequency touch signals may be determined by the Equation 410 of FIG. 8 or the Equation 420 of FIG. 9.

$$Frequency separation {phase}_{Hadamard}^{2} ( 8 , 4 ) = Frequency separation {phase}_{Hadamard}^{1} ( 8 , 4 ) ∘ {Hadamard ( 8 )}_{3} \qquad [ Equation 420 ]$$

In Equation 420,

$$Frequency separation {phase}_{Hadamard}^{2} ( 8 , 4 )$$

may be the second phase shift matrix,

$$Frequency separation {phase}_{Hadamard}^{1} ( 8 , 4 )$$

may be the first phase shift matrix, and Hadamard(8)₃ may represent a third row of the 8×8 Hadamard matrix. Since the first phase shift matrix is “[1 i 1 i 1 i 1 i]” and the third row of the 8×8 Hadamard matrix is “[1 1 −1 −1 1 1 −1 −1]”, the second phase shift matrix may be a result of the Hadamard product (or the element-wise product) of “[1 i l i 1 i 1 i]” and “[1 1 −1 −1 1 1 −1 −1]”, which may be “[1 i −1 −i 1 i −1 −i]”.

Further, the second frequency touch signals may be determined by applying the second phase shift matrix, or “[1 i −1 −i 1 i −1 −i]” to the eight orthogonal codes. For example, to determine the second frequency touch signals, the first and fifth orthogonal codes may be multiplied by “1”, the second and fifth orthogonal codes may be multiplied by “i”, the third and seventh orthogonal codes may be multiplied by “−1”, and the fourth and eighth orthogonal codes may be multiplied by “−i”. A sum signal of the second frequency touch signals determined in this manner may have equal power in two other code symbols different from the two code symbols where the sum signal of the first frequency touch signals has equal power, and may be canceled out in the remaining six code symbols.

In other words, as shown in FIG. 10, the matrix multiplication of the second phase shift matrix 430 and the 8×8 Hadamard matrix 440 may correspond to the sum signal of the second frequency touch signals. Further, a result 450 of the matrix multiplication of the second phase shift matrix 430 and the 8×8 Hadamard matrix 440 may have a same absolute value in the third code symbol CS3 and the fourth code symbol CS4, and may have a value of 0 in the first code symbol CS1, the second code symbol CS2, the fifth code symbol CS5, the sixth code symbol CS6, the seventh code symbol CS7 and the eighth code symbol CS8. This may mean that the sum signal of the second frequency touch signals has equal power in the third and fourth code symbols CS3 and CS4, and is canceled out in the first, second and fifth through eighth code symbols CS1, CS2 and CS5 through CS8.

FIG. 11 shows the second frequency touch signals F2_TX1, F2_TX2, F2_TX3, F2_TX4, F2_TX5, F2_TX6, F2_TX7 and F2_TX8 determined as described above, and the sum signal F2_TXS of the second frequency touch signals F2_TX1 through F2_TX8. As illustrated in FIG. 11, the sum signal F2_TXS of the second frequency touch signals may be a signal obtained by summing four sine signals of which phases are not shifted and four sine signals of which phases are shifted by about 90 degrees in the third period P3, and may be a signal obtained by summing four sine signals of which phases are not shifted and four sine signals of which phases are shifted by about 270 degrees in the fourth period P4. Thus, the sum signal F2_TXS of the second frequency touch signals may have a same absolute value in the third period P3 and the fourth period P4, and may have equal power in the third period P3 and the fourth period P4. Further, in each of the first, second and fifth through eighth periods P1, P2 and P5 through P8, the sum signal F2_TXS of the second frequency touch signals may be a signal obtained by summing two sine signals of which phases are not shifted, two sine signals of which phases are shifted by about 90 degrees, two sine signals of which phases are shifted by about 180 degrees, and two sine signals of which phases are shifted by about 270 degrees. Thus, in each of the first, second and fifth through eighth periods P1, P2 and P5 through P8, the sum signal F2_TXS of the second frequency touch signals may be a signal having amplitude of about 0, and the second frequency touch signals F2_TX1 through F2_TX8 may be canceled out.

In this way, a third phase shift matrix may be determined by shifting the first phase shift matrix, and third frequency touch signals having a third frequency may be determined by applying the third phase shift matrix to the orthogonal codes. Further, a fourth phase shift matrix may be determined by shifting the first phase shift matrix, and fourth frequency touch signals having a fourth frequency may be determined by applying the fourth phase shift matrix to the orthogonal codes. The first frequency touch signals, the second frequency touch signals, the third frequency touch signals and the fourth frequency touch signals generated in this manner may have equal power in different code symbols or in different periods.

FIG. 12 shows an example of a sum signal of thirty two touch signals TXS using eight orthogonal codes the four frequencies. For example, as shown in FIG. 12, in the sum signal of the thirty two touch signals TXS, the sum signal F1_TXS of the first frequency touch signals may have equal power in the first and second code symbols CS1 and CS2 or in the first and second periods P1 and P2, the sum signal F2_TXS of the second frequency touch signals may have equal power in the third and fourth code symbols CS3 and CS4 or in the third and fourth periods P3 and P4, the sum signal F3_TXS of the third frequency touch signals may have equal power in the fifth and sixth code symbols CS5 and CS6 or in the fifth and sixth periods P5 and P6, and the sum signal F4_TXS of the fourth frequency touch signals may have equal power in the seventh and eighth code symbols CS7 and CS8 or in the seventh and eighth periods P7 and P8.

As described above, in the method of determining the touch signals using the N×N Hadamard matrix according to embodiments, the N×m touch signals using N orthogonal codes and m frequencies may be determined such that the sum signal of the touch signals having a same frequency may have equal power in N/m code symbols (or N/m periods), the sum signal of the touch signals having a same frequency may be canceled out in the remaining (N−N/m) code symbols (or the remaining (N−N/m) periods), and the sum signals associated with different frequencies may have equal power in different code symbols or different periods. For example, each of the code symbols CS1 through CS8 may be assigned to one of different frequencies, and thus an increase in peak power and signal distortion due to the overlapping or accumulation of different frequency signals in each code symbol or each period may be reduced or prevented.

FIG. 13 is a graph showing cumulative distributions of PAPRs of sum signals of touch signals in case that a phase is not shifted, in case that the phase is shifted in a random manner, in case that the phase is shifted in a stack manner, and in case that the phase is shifted by a method of FIG. 2.

FIG. 13 shows, with respect to thirty two touch signals using eight rows of an 8×8 Hadamard matrix as eight orthogonal codes and four frequencies randomly selected in a frequency range of about 100 kHz to about 500 kHz, a cumulative distribution of PAPR 460 generated by measuring the PAPR of a sum signal of the touch signals multiple times (e.g., about 10,000 times) in case that a phase is not shifted, a cumulative distribution of PAPR 470 generated by measuring the PAPR of the sum signal of the touch signals multiple times in case that the phase is shifted in a random manner, a cumulative distribution of PAPR 480 generated by measuring the PAPR of the sum signal of the touch signals multiple times in case that the phase is shifted in a stack manner that sequentially determines phases of respective touch signals, and a cumulative distribution of PAPR 490 generated by measuring the PAPR of the sum signal of the touch signals multiple times in the a where the phase is shifted based on the method of FIG. 2 according to embodiments.

As shown in FIG. 13, the PAPR 460 in case that the phase is not shifted may have an average value of about 17 dB, the PAPR 470 in case that the phase is shifted in the random manner may have an average value of about 11 dB, and the PAPR 480 in case that the phase is shifted in the stack manner may have an average value of about 8.5 dB. However, in case that the phase is shifted based on the method of FIG. 2 according to embodiments, even if the four frequencies are randomly selected, the PAPR 490 may be maintained at a relatively low level of about 3 dB.

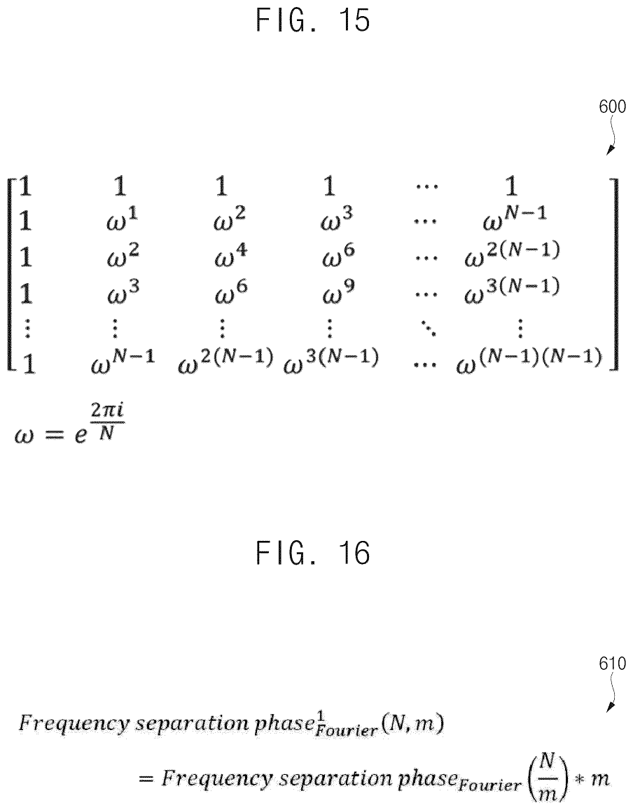

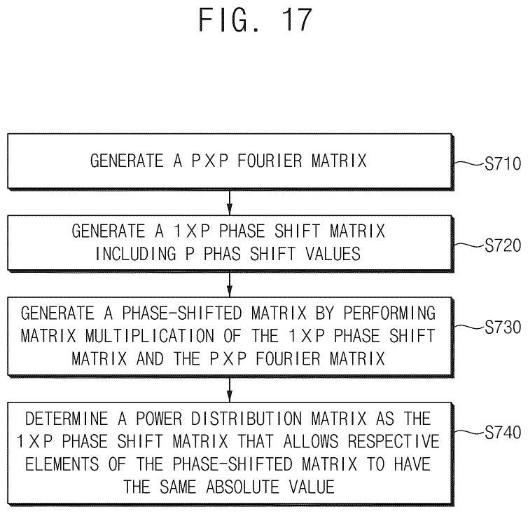

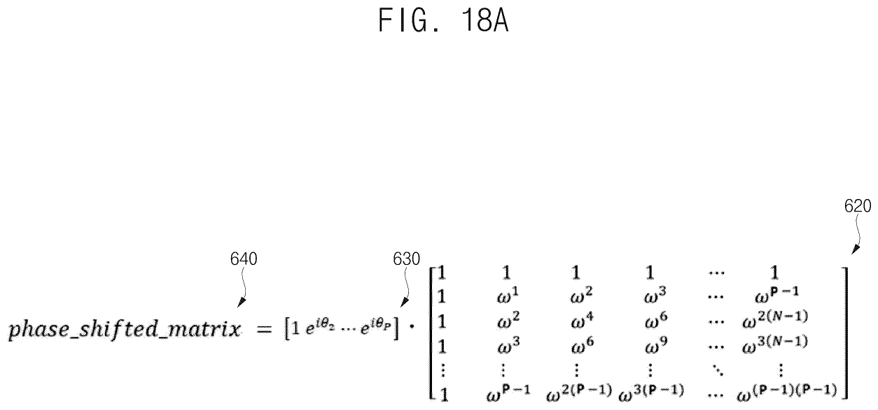

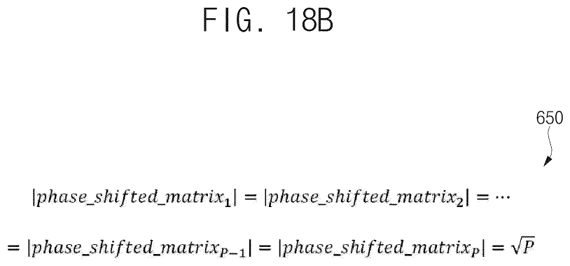

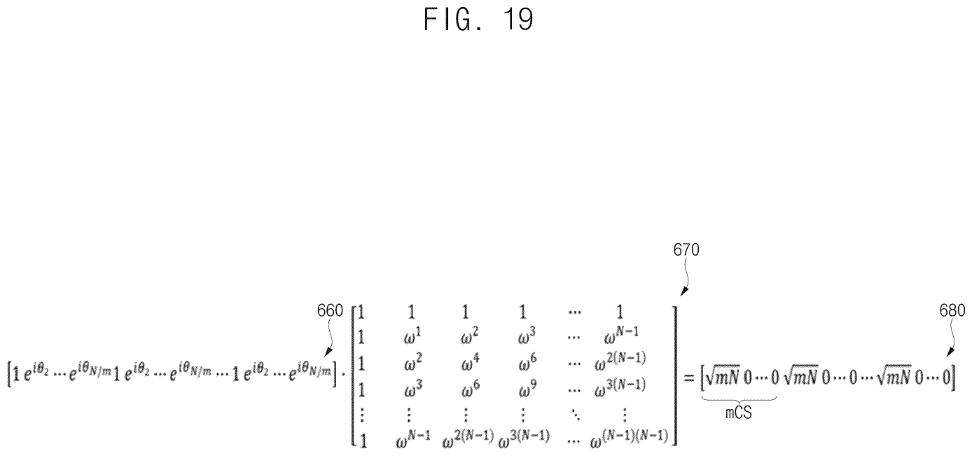

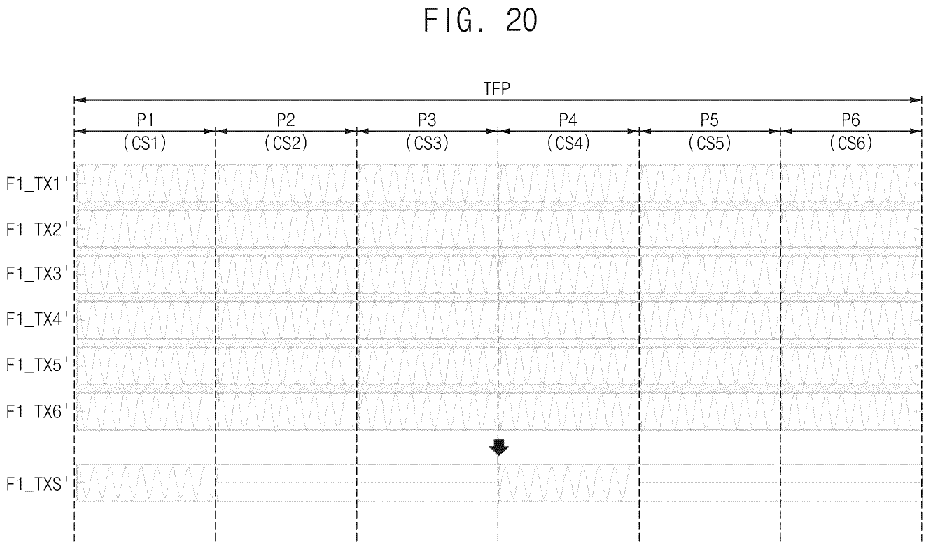

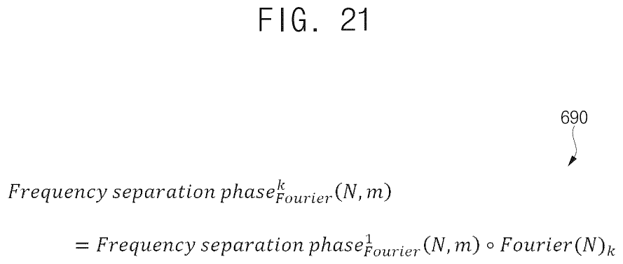

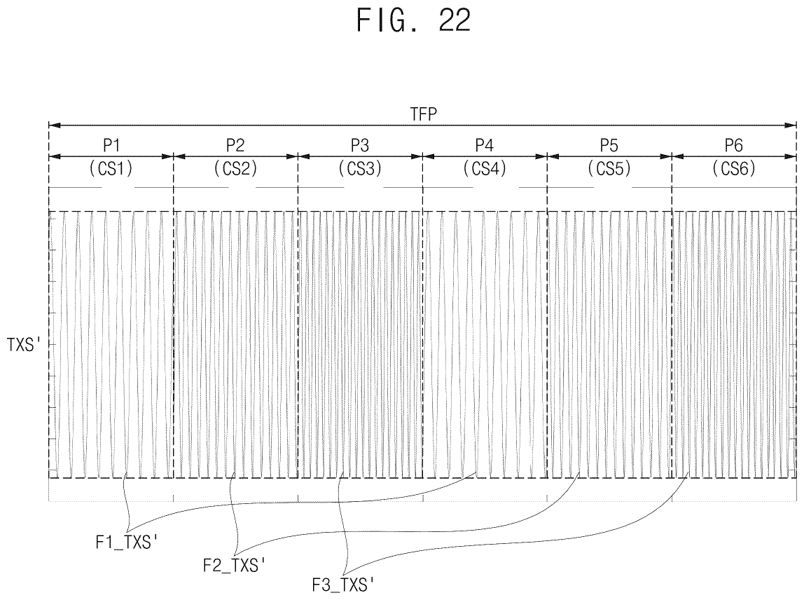

FIG. 14 is a flowchart illustrating a method for determining a touch signal using a Fourier matrix according to embodiments, FIG. 15 is an example of an N×N Fourier matrix, FIG. 16 is an equation for determining a first phase shift matrix for first frequency touch signals, FIG. 17 is a flowchart illustrating a method for determining a power distribution matrix for an (N/m)×(N/m) Fourier matrix, FIG. 18A is an equation for generating a phase-shifted matrix, FIG. 18B is an equation for determining a power distribution matrix, FIG. 19 is an example of a sum of orthogonal codes to which a first phase shift matrix is applied, FIG. 20 is a schematic timing diagram illustrating an example of first frequency touch signals and a sum signal of the first frequency touch signals, FIG. 21 is an equation for determining a k-th phase shift matrix by shifting a first phase shift matrix, and FIG. 22 is a schematic timing diagram illustrating an example of a sum signal of eighteen touch signals in case that six orthogonal codes and three frequencies are used.

Referring to FIG. 14, in a method of determining N×m touch signals using N orthogonal codes and m frequencies according to embodiments, where N may be an integer greater than or equal to 2, and m may be an integer greater than or equal to 2, an N×N Fourier matrix including N rows and N columns may be generated (S510). The N rows of the N×N Fourier matrix may be the N orthogonal codes. For example, as shown in FIG. 15, a first orthogonal code may be “[1 1 1 1 . . . 1]”, a second orthogonal code may be “[1 ω1 ω2 ω3 . . . ωN−1]”, and an N-th orthogonal code may be “[1 ωN−1 ω2 (N−1) ω3 (N−1) . . . ω(N−1)(N−1)]”, where

$$ω = {e}^{\frac{2 π i}{N}} .$$

A first phase shift matrix representing phase shift values for first frequency touch signals having a first frequency among the N×m touch signals may be determined (S520). The first phase shift matrix may be determined such that a sum signal of the first frequency touch signals may have equal power in N/m code symbols (N/m periods) among the N code symbols (or N periods into which a touch frame period is divided) and may be canceled out in the remaining (N−N/m) code symbols (or the remaining (N−N/m) periods) among the N code symbols. In some embodiments, a power distribution matrix for an (N/m)×(N/m) Fourier matrix may be generated (S522), and the first phase shift matrix may be determined by concatenating the power distribution matrix m times (S524).

For example, as shown in FIG. 16, the first phase shift matrix may be determined by Equation 610.

$$Frequency separation {phase}_{Fourier}^{1} ( N , m ) = Frequency separation {phase}_{Fourier} ( \frac{N}{m} ) ⋆ m , , . \qquad [ Equation 610 ]$$

In Equation 610,

$$Frequency separation {phase}_{Fourier}^{1} ( N , m )$$

may be the first phase shift matrix,

$$Frequency separation {phase}_{Fourier} ( \frac{N}{m} )$$

may be a power distribution matrix for the (N/m)×(N/m) Fourier matrix, and

$$Frequency separation {phase}_{Fourier} ( \frac{N}{m} ) ⋆ m$$

may be obtained by concatenating the power distribution matrix m times.

In some embodiments, to generate the power distribution matrix for the (N/m)×(N/m) Fourier matrix, as illustrated in FIGS. 17 and 18A, a P×P Fourier matrix 620 may be generated, where P may be an integer that is N/m (S710). Further, P phases for P rows of the P×P Fourier matrix 620 may be set as θ₁, θ₂, . . . and θ_{P}, respectively, and a 1×P phase shift matrix 630 including phase shift values that apply the P phases to the P rows of the P×P Fourier matrix 620 may be generated (S720). The phase for a first row of the P×P Fourier matrix 620, or θ₁ may be 0. Further, as shown in FIG. 18A, a 1×P phase-shifted matrix 640 may be generated by performing matrix multiplication of the 1×P phase shift matrix 630 and the P×P Fourier matrix 620 (S730). The power distribution matrix may be determined as the 1×P phase shift matrix 630 that allows respective elements of the 1×P phase-shifted matrix 640 to have a same absolute value (S740). For example, the power distribution matrix may be determined by determining θ₂, . . . and θ_{P} using Equation 650 illustrated in FIG. 18B,

$$\vert phase\_shifted {\_matrix}_{1} \vert = \vert phase\_shifted {\_matrix}_{2} \vert = … = \vert phase\_shifted {\_matrix}_{p - 1} \vert = \vert phase\_shifted {\_matrix}_{p} \vert = \sqrt{P} \cdot ” , \qquad [ Equation 650 ]$$

and by substituting the determined θ₂, . . . and θ_{P} into the 1×P phase shift matrix 630. θ₂, . . . and θ_{P} may be determined by calculating Equation 650, or P nonlinear simultaneous equations for (P−1) variables. Using the power distribution matrix determined in this manner, the first phase shift matrix may be

$$Frequency separation {phase}_{Fourier}^{1} ( N , m ) = Frequency separation {phase}_{Fourier} ( \frac{N}{m} ) ⋆ m = [ 1 {e}^{i {θ}_{2}} … {e}^{i {θ}_{N / m}} ] ⋆ m$$

expressed as an equation, or

$$“ = [ 1 {e}^{i {θ}_{2}} … {e}^{i {θ}_{N / m}} 1 {e}^{i {θ}_{z}} … {e}^{i {θ}_{N / m}} … 1 {e}^{i {θ}_{2}} … {e}^{i {θ}_{N / m}} ] ” .$$

Referring again to FIG. 14, the first frequency touch signals may be determined by applying the first phase shift matrix to the N orthogonal codes (S530). In some embodiments, elements of the first phase shift matrix may be respectively multiplied by the orthogonal codes to generate phase-shifted orthogonal codes, and the first frequency touch signals may be generated based on the phase-shifted orthogonal codes. A sum signal of the first frequency touch signals generated in this way may have equal power in N/m code symbols, and may be canceled out in the remaining (N−N/m) code symbols.

For example, as shown in FIG. 19, the matrix multiplication of the first phase shift matrix 660 and the N×N Fourier matrix 670 including the N orthogonal codes may correspond to the sum signal of the first frequency touch signals. Further, a result 680 of the matrix multiplication of the first phase shift matrix 660 and the N×N Fourier matrix 670 may have a value of \sqrt{mN} in one of m consecutive code symbols mCS, and may have a value of 0 in the remaining code symbols among the m consecutive code symbols mCS. In the result 680 of the matrix multiplication, the m consecutive code symbols mCS may be repeated N/m times. Thus, the result 680 of the matrix multiplication may have a same absolute value in the N/m code symbols, and may have a value of 0 in the remaining (N−N/m) code symbols. This may mean that the sum signal of the first frequency touch signals has equal power in the N/m code symbols or N/m periods, and is canceled out in the remaining (N−N/m) code symbols or the remaining (N−N/m) periods.

FIG. 20 shows the first frequency touch signals F1_TX1′, F1_TX2′, F1_TX3′, F1_TX4′, F1_TX5′ and F1_TX6′ determined as described above, and the sum signal F1_TXS' of the first frequency touch signals F1_TX1′ through F1_TX6′ in case that six orthogonal codes are used and three frequencies are used. As shown in FIG. 20, the sum signal F1_TXS' of the first frequency touch signals may have equal power in a first period P1 and a fourth period P4. Further, in a second period P2, a third period P3, a fifth period P5 and a sixth period P6, the sum signal F1_TXS' of the first frequency touch signals may be a signal having amplitude of about 0, and the first frequency touch signals F1_TX1′ through F1_TX8′ may be canceled out.

Referring again to FIG. 14, a k-th phase shift matrix may be determined by shifting the first phase shift matrix, where k may be an integer greater than or equal to 2 and less than or equal to m (S550), and k-th frequency touch signals having a k-th frequency may be determined by applying the k-th phase shift matrix to the orthogonal codes (S560). In some embodiments, the k-th phase shift matrix may be determined by performing a Hadamard product (or an element-wise product) on the first phase shift matrix and a k-th row of the N×N Fourier matrix. For example, as shown in FIG. 21, the k-th phase shift matrix may be determined by Equation 690.

$$Frequency separation {phase}_{Fourier}^{k} ( N , m ) = Frequency separation {phase}_{Fourier}^{1} ( N , m ) ∘ {Fourier ( N )}_{k} \qquad [ Equation 690 ]$$

In Equation 690,

$$Frequency separation {phase}_{Fourier}^{k} ( N , m )$$

may be the k-th phase shift matrix,

$$Frequency separation {phase}_{Fourier}^{1} ( N , m )$$

may be the first phase shift matrix, Fourier(N)ₖ may represent the k-th row of the N×N Fourier matrix, and an operator ‘∘’ may represent the Hadamard product. The sum signal of the k-th frequency touch signals determined in this manner may have equal power in N/m other code symbols different from the code symbols in which another sum signal of other frequency touch signals has equal power, and may be canceled out in the remaining (N−N/m) code symbols. Determining the k-th phase shift matrix and determining the k-th frequency touch signals may be repeatedly performed until second frequency touch signals through m-th frequency touch signals are determined (S540, S550, S560, S570 and S580).

FIG. 22 shows an example of a sum signal of eighteen touch signals TXS' using six orthogonal codes and three frequencies. For example, as shown in FIG. 22, in the sum signal of the eighteen touch signals TXS′, the sum signal F1_TXS' of the first frequency touch signals may have equal power in the first and fourth code symbols CS1 and CS4 or in the first and fourth periods P1 and P4, the sum signal F2_TXS' of the second frequency touch signals may have equal power in the second and fifth code symbols CS2 and CS5 or in the second and fifth periods P2 and P5, and the sum signal F3_TXS' of the third frequency touch signals may have equal power in the third and sixth code symbols CS3 and CS6 or in the third and sixth periods P3 and P6.

As described above, in the method of determining the touch signals using the N×N Fourier matrix according to embodiments, the N×m touch signals using N orthogonal codes and m frequencies may be determined such that the sum signal of the touch signals having a same frequency may have equal power in N/m code symbols (or N/m periods), the sum signal of the touch signals having a same frequency may be canceled out in the remaining (N−N/m) code symbols (or the remaining (N−N/m) periods), and the sum signals associated with different frequencies may have equal power in different code symbols or different periods. For example, each of the code symbols CS1 through CS6 may be assigned to one of different frequencies, and thus an increase in peak power and signal distortion due to the overlapping or accumulation of different frequency signals in each code symbol or each period may be reduced or prevented.

FIG. 23 is a graph showing cumulative distributions of PAPRs of sum signals of touch signals in case that a phase is not shifted, in case that the phase is shifted in a random manner, in case that the phase is shifted in a stack manner, and in case that the phase is shifted by a method of FIG. 14.

FIG. 23 shows, with respect to eighteen touch signals using six rows of a 6×6 Fourier matrix as six orthogonal codes and three frequencies randomly selected in a frequency range of about 100 kHz to about 500 kHz, a cumulative distribution of PAPR 810 generated by measuring the PAPR of a sum signal of the touch signals multiple times (e.g., about 10,000 times) in case that a phase is not shifted, a cumulative distribution of PAPR 820 generated by measuring the PAPR of the sum signal of the touch signals multiple times in case that the phase is shifted in a random manner, a cumulative distribution of PAPR 830 generated by measuring the PAPR of the sum signal of the touch signals multiple times in case that the phase is shifted in a stack manner that sequentially determines phases of respective touch signals, and a cumulative distribution of PAPR 840 generated by measuring the PAPR of the sum signal of the touch signals multiple times in case that the phase is shifted based on the method of FIG. 14 according to embodiments.

As shown in FIG. 23, the PAPR 810 in case that the phase is not shifted may have an average value of about 15.5 dB, the PAPR 820 in case that the phase is shifted in the random manner may have an average value of about 9.5 dB, and the PAPR 830 in case that the phase is shifted in the stack manner may have an average value of about 7 dB. However, in case that the phase is shifted based on the method of FIG. 14 according to embodiments, even if the three frequencies are randomly selected, the PAPR 840 may be maintained at a relatively low level of about 3 dB.

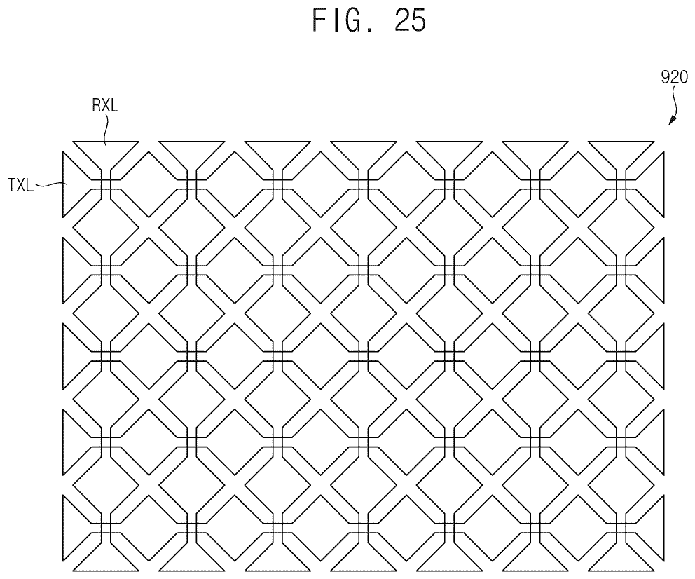

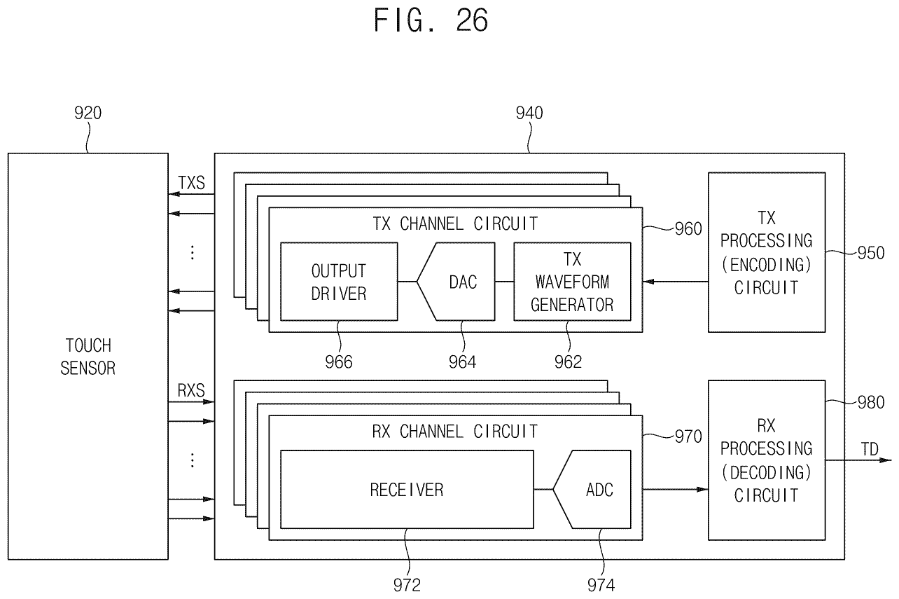

FIG. 24 is a schematic block diagram illustrating a display device according to embodiments, FIG. 25 is a schematic diagram illustrating a touch sensor included in a display device according to embodiments, and FIG. 26 is a schematic diagram illustrating a touch controller included in a display device according to embodiments.

Referring to FIG. 24, a display device 900 according to embodiments may include a display panel 910 that includes multiple pixels PX, a touch sensor 920 for sensing a touch of a user, a display driver 930 that drives the pixels PX, and a touch controller 940 that drives the touch sensor 920.

The display panel 910 may be driven by the display driver 930 to display an image. The display panel 910 may include multiple data lines, multiple scan lines, and the pixels PX connected to the data lines and the scan lines. In some embodiments, each pixel PX may include a light-emitting element, and the display panel 910 may be a light-emitting display panel. For example, the light-emitting element may be an organic light-emitting diode (“OLED”), a micro light-emitting diode, a nano light-emitting diode (“NED”), a quantum dot (“QD”) light-emitting diode, an inorganic light-emitting diode, or any other suitable light-emitting element. However, the display panel 910 is not limited to the light-emitting display panel, and may be any other suitable display panel.

The display driver 930 may drive the display panel 910 based on input image data IDAT and a control signal CTRL provided from an external processor (e.g., a graphics processing unit (“GPU”), an application processor (“AP”) or a graphics card). In some embodiments, the input image data IDAT may be RGB image data including red image data, green image data, and blue image data. Further, in some embodiments, the control signal CTRL may include, but is not limited to, an input data enable signal, a master clock signal, a vertical synchronization signal, a horizontal synchronization signal, etc. The display driver 930 may generate a display panel driving signal DPS based on the input image data IDAT and the control signal CTRL, and may drive the display panel 910 by providing the display panel driving signal DPS to the display panel 910. In some embodiments, the display panel driving signal DPS may include a scan signal, a data signal and an emission signal, and the display driver 930 may include, but is not limited to, a scan driver that provides a scan signal to the display panel 910, a data driver that provides a data signal to the display panel 910, an emission driver that provides an emission signal to the display panel 910, and a timing controller that controls the scan driver, the data driver, and the emission driver.

The touch sensor 920 may be a capacitance-type touch sensor that detects a capacitance change due to a touch of a conductive object (e.g., a finger, a stylus pen, etc.). In some embodiments, as illustrated in FIG. 25, the touch sensor 920 may include multiple touch transmission electrodes TXL and multiple touch reception electrodes RXL intersecting the touch transmission electrodes TXL. For example, the touch sensor 920 may be a one layer touch sensor in which the touch transmission electrodes TXL and the touch reception electrodes RXL are arranged in a same layer. Further, as illustrated in FIG. 25, each of the touch transmission electrodes TXL and the touch reception electrodes RXL may have, but is not limited to, a structure in which continuous polygonal (e.g., diamond-shaped) electrodes are connected. According to embodiments, the touch sensor 920 may be an add-on type touch sensor attached to the display panel 910, or an embedded type touch sensor formed inside the display panel 910. For example, the touch sensor 920 may be, but is not limited to, an on-cell type embedded touch sensor or an in-cell type embedded touch sensor. Although FIG. 25 illustrates five touch transmission electrodes TXL, the disclosure is not limited thereto, and the touch sensor 920 according to embodiments may include N×m touch transmission electrodes TXL in case that N orthogonal codes and m frequencies are used to generate touch signals TXS, where each of N and m may be an integer greater than or equal to 2.

The touch controller 940 may drive the touch sensor 920 to detect a touch and/or proximity of the conductive object. For example, the touch controller 940 may apply N×m touch signals TXS to the N×m touch transmission electrodes TXL, respectively. By capacitive coupling between the N×m touch transmission electrodes TXL and the touch reception electrodes RXL, a touch reception signal RXS corresponding to a sum signal of the N×m touch signals TXS may be induced to each of the touch reception electrodes RXL. The touch controller 940 may receive the touch reception signal RXS from each of the touch reception electrodes RXL, and may detect the touch by detecting a change in mutual capacitance caused by the touch of the conductive object based on the touch reception signal RXS.

In some embodiments, as illustrated in FIG. 26, the touch controller 940 may include a transmission processing circuit (or TX processing circuit) 950 that performs an encoding operation, N×m transmission channel circuits (or TX channel circuit) 960 respectively connected to the N×m touch transmission electrodes TXL, multiple reception channel circuits 970 respectively connected to the touch reception electrodes RXL, and a reception processing circuit (or RX processing circuit) 980 that performs a decoding operation.

The transmission processing circuit 950 may store an orthogonal matrix including N orthogonal codes, and first through m-th phase shift matrices respectively associated with first through m-th frequencies, which are determined as described above with reference to FIGS. 1 through 23. In some embodiments, the orthogonal matrix may be an N×N Hadamard matrix, and the first through m-th phase shift matrices may be determined by the method described above with reference to FIGS. 2 through 13. In other embodiments, the orthogonal matrix may be an N×N Fourier matrix, and the first through m-th phase shift matrices may be determined by the method described above with reference to FIGS. 14 through 23. The transmission processing circuit 950 may apply the first through m-th phase shift matrices to the N orthogonal codes to generate N×m phase-shifted orthogonal codes.

The N×m transmission channel circuits 960 may respectively receive the N×m phase-shifted orthogonal codes from the transmission processing circuit 950, may generate N×m touch signals TXS based on the N×m phase-shifted orthogonal codes, and may transmit the N×m touch signals TXS to the N×m touch transmission electrodes TXL, respectively. In some embodiments, each transmission channel circuit 960 may include a transmission waveform generator (or TX waveform generator) 962 that generates touch signal digital data based on a corresponding phase-shifted orthogonal code, a digital-to-analog converter (“DAC”) 964 that performs digital-to-analog conversion on the touch signal digital data to generate the touch signal TXS, and an output driver 966 that transmits the touch signal TXS to a corresponding touch transmission electrode TXL.

The reception channel circuits 970 may be respectively connected to the touch reception electrodes RXL. Each reception channel circuit 970 may receive a touch reception signal RXS corresponding to a sum signal of the N×m touch signals TXS from a corresponding touch reception electrode RXL, and may generate sum signal data by performing analog-to-digital conversion on the touch reception signal RXS, or the sum signal of the N×m touch signals TXS. In some embodiments, each reception channel circuit 970 may include a receiver 972 that receives the touch reception signal RXS, or the sum signal of the N×m touch signals TXS from the corresponding touch reception electrode RXL, and an analog-to-digital converter (“ADC”) 974 that performs analog-to-digital conversion on the touch reception signal RXS, or the sum signal of the N×m touch signals TXS.

The reception processing circuit 980 may receive the sum signal data from each of the reception channel circuits 970, and may generate touch signal data TD for the N×m touch signals TXS. For example, the reception processing circuit 980 may generate touch signal data TD for the N×m touch signals TXS having respective orthogonal codes and respective frequencies by performing a decoding operation on the sum signal data for the sum signal of the N×m touch signals TXS. The reception processing circuit 980 may provide the touch signal data TD to the external host, or may provide the touch signal data TD to the timing controller of the display driver 930.

As described above, in the display device 900 according to embodiments, the touch controller 940 may generate N×m touch signals TXS based on orthogonal matrix and first through m-th phase shift matrices determined as described above with reference to FIGS. 1 through 23. Accordingly, the peak to average power ratio (“PAPR”) of the sum signal of the N×m touch signals TXS may be reduced, and the touch sensitivity and accuracy of the touch sensor 920 may be improved.

The display device 900 according to embodiments may be applied to various electronic devices. An electronic device according to embodiments may include the display device 900 described above, and may further include a module or device having additional functions in addition to the display device 900.

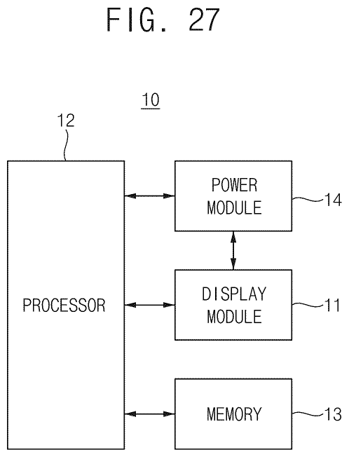

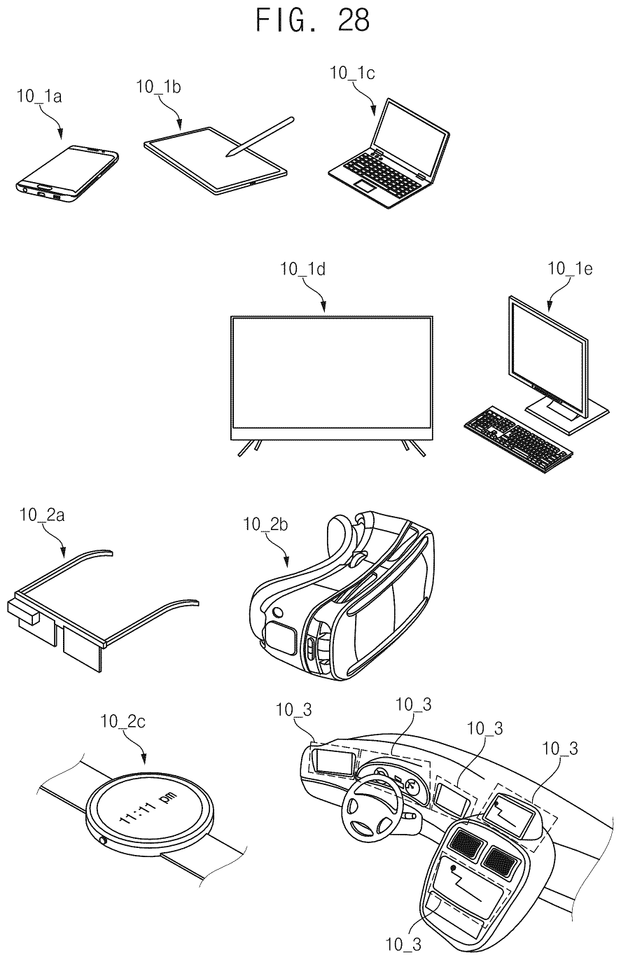

FIG. 27 is a schematic block diagram illustrating an electronic device according to embodiments.

Referring to FIG. 27, an electronic device 10 according to embodiments may include a display module 11, a processor 12, a memory 13 and a power module 14.

The processor 12 may include at least one of a central processing unit (“CPU”), an application processor (“AP”), a graphics processing unit (“GPU”), a communication processor (“CP”), an image signal processor (“ISP”) and a controller.

The memory 13 may store data information for an operation of the processor 12 or the display module 11. In case that the processor 12 executes an application stored in the memory 13, an image data signal and/or an input control signal may be transferred to the display module 11, and the display module 11 may output image information through a display screen by processing the received signal.

The power module 14 may include a power supply module such as a power adapter or a battery device, and a power conversion module that converts power supplied by the power supply module to generate power required for an operation of the electronic device 10.

At least one of the components of the electronic device 10 described above may be included in the display device according to embodiments described above. Further, some of individual modules functionally included in one module may be included in the display device, and other modules may be provided separately from the display device. For example, the display device may include the display module 11, and the processor 12, the memory 13 and the power module 14 may be provided in other devices in the electronic device 10 other than the display device.

FIG. 28 is a schematic diagram of an electronic device according to various embodiments.

Referring to FIG. 28, various electronic devices to which the display device according to embodiments is applied may include not only image display electronic devices such as a smart phone 10_1a, a tablet personal computer (“PC”) 10_1b, a laptop 10_1c, a television (“TV”) 10_1d and a desk monitor 10_1e, but also wearable electronic devices including display modules such as smart glasses 10_2a, a head mounted display 10_2b and a smart watch 10_2c, and vehicle electronic devices 10_3 including display modules such as a center information display (“CID”) arranged on an instrument panel, center fascia and dashboard of an automobile, and a room mirror display.

The above description is an example of technical features of the disclosure, and those skilled in the art to which the disclosure pertains will be able to make various modifications and variations. Therefore, the embodiments of the disclosure described above may be implemented separately or in combination with each other.

Therefore, the embodiments disclosed in the disclosure are not intended to limit the technical spirit of the disclosure, but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. A method of determining N×m touch signals for a touch sensor including N×m touch transmission electrodes, where each of N and m is an integer greater than or equal to 2, the method comprising:
generating an orthogonal matrix including N orthogonal codes;
determining a first phase shift matrix for N first frequency touch signals such that a sum signal of the N first frequency touch signals having a first frequency has equal power in N/m code symbols among N code symbols and is canceled out in remaining (N−N/m) code symbols among the N code symbols;
determining the N first frequency touch signals by applying the first phase shift matrix to the N orthogonal codes;
determining a k-th phase shift matrix for N k-th frequency touch signals having a k-th frequency by shifting the first phase shift matrix, where k is an integer greater than or equal to 2 and less than or equal to m; and
determining the N k-th frequency touch signals by applying the k-th phase shift matrix to the N orthogonal codes.

2. The method of claim 1, wherein a sum signal of the N k-th frequency touch signals has equal power in N/m other code symbols among the remaining (N−N/m) code symbols where the sum signal of the N first frequency touch signals is canceled out, and is canceled out in other remaining (N−N/m) code symbols excluding the N/m other code symbols among the N code symbols.

3. The method of claim 1, wherein the orthogonal matrix is an N×N Hadamard matrix.

4. The method of claim 1, wherein
the first phase shift matrix is determined by Equation 1,
$$Frequency separation {phase}_{Hadamard}^{1} ( N , m ) = Frequency separation {phase}_{Hadamard} ( \frac{N}{m} ) ⋆ m , \qquad [ Equation 1 ]$$
wherein in Equation 1,
$$Frequency separation {phase}_{Hadamard}^{1} ( N , m )$$
is the first phase shift matrix,
$$Frequency separation {phase}_{Hadamard} ( \frac{N}{m} )$$
is a power distribution matrix for an (N/m)×(N/m) Hadamard matrix, and
$$Frequency separation {phase}_{Hadamard} ( \frac{N}{m} ) ⋆ m$$
is obtained by concatenating the power distribution matrix m times.

5. The method of claim 4, wherein,
in case that N/m is 2\hat{ }p and p is 2q, where p is an integer greater than or equal to 1 and q is an integer greater than or equal to 0, the power distribution matrix is determined by Equation 2,
$$Frequency separation {phase}_{Hadamard} ( {2}^{p} ) = Hadamard ( {2}^{q} ) , \qquad [ Equation 2 ]$$
and
in case that N/m is 2\hat{ }p and p is 2q+1, the power distribution matrix is determined by Equation 3,
$$Frequency separation {phase}_{Hadamard} ( {2}^{p} ) = Hadamard ( {2}^{q} ) + i \times Hadamard ( {2}^{q} ) , \qquad [ Equation 3 ]$$
and
wherein in Equations 2 and 3,
Frequency separation phase_{Hadamard}(2^{p}) is the power distribution matrix,
Hadamard (2^{q}) is a (2\hat{ }q)×(2\hat{ }q) Hadamard matrix, and
i represents a unit imaginary number.

6. The method of claim 1, wherein
the k-th phase shift matrix is determined by Equation 4,
$$Frequency separation {phase}_{Hadamard}^{k} ( N , m ) = Frequency separation {phase}_{Hadamard}^{1} ( N , m ) ∘ {Hadamard ( N )}_{\frac{N}{m} ( k - 1 ) + 1} , \qquad [ Equation 4 ]$$
wherein in Equation 4,
$$Frequency separation {phase}_{Hadamard}^{k} ( N , m )$$
is the k-th phase shift matrix,
$$Frequency separation {phase}_{Hadamard}^{1} ( N , m )$$
is the first phase shift matrix,
$${Hadamard ( N )}_{\frac{N}{m} ( k - 1 ) + 1}$$
represents a
$$\frac{N}{m} ( k - 1 ) + 1$$
-th row of an N×N Hadamard matrix, and
an operator ‘∘’ represents a Hadamard product.

7. The method of claim 1, wherein the orthogonal matrix is an N×N Fourier matrix.

8. The method of claim 1, wherein
the first phase shift matrix is determined by Equation 5,
$$Frequency separation {phase}_{Fourier}^{1} ( N , m ) = Frequency separation {phase}_{Fourier} ( \frac{N}{m} ) * m , \qquad [ Equation 5 ]$$
wherein in Equation 5,
$$Frequency separation {phase}_{Fourier}^{1} ( N , m )$$
is the first phase shift matrix,
$$Frequency separation {phase}_{Fourier} ( \frac{N}{m} )$$
is a power distribution matrix for an (N/m)×(N/m) Fourier matrix, and
$$Frequency separation {phase}_{Fourier} ( \frac{N}{m} ) * m$$
is obtained by concatenating the power distribution matrix m times.

9. The method of claim 8, further comprising:
generating a P×P Fourier matrix, P being an integer of N/m;
generating a 1×P phase shift matrix including P phase shift values for P rows of the P×P Fourier matrix;
generating a phase-shifted matrix by performing matrix multiplication of the 1×P phase shift matrix and the P×P Fourier matrix; and
determining the power distribution matrix as the 1×P phase shift matrix that allows respective elements of the phase-shifted matrix to have a same absolute value.

10. The method of claim 1, wherein
the k-th phase shift matrix is determined by Equation 6,
$$Frequency separation {phase}_{Fourier}^{k} ( N , m ) = Frequency separation {phase}_{Fourier}^{1} ( N , m ) ∘ {Fourier ( N )}_{k} , \qquad [ Equation 6 ]$$
wherein in Equation 6,
$$Frequency separation {phase}_{Fourier}^{k} ( N , m )$$
is the k-th phase shift matrix,
$$Frequency separation {phase}_{Fourier}^{1} ( N , m )$$
is the first phase shift matrix, Fourier(N)ₖ represents a k-th row of an N×N Fourier matrix, and an operator ‘∘’ represents a Hadamard product.

11. A display device comprising:
a display panel including a plurality of pixels;
a touch sensor including N×m touch transmission electrodes, where each of N and m is an integer greater than or equal to 2;
a display driver that drives the plurality of pixels; and
a touch controller that drives the touch sensor, the touch controller including:
a transmission processing circuit that stores an orthogonal matrix including N orthogonal codes, and first through m-th phase shift matrices respectively associated with first through m-th frequencies, and generates N×m phase-shifted orthogonal codes by applying the first through m-th phase shift matrices to the N orthogonal codes; and
N×m transmission channel circuits that respectively receive the N×m phase-shifted orthogonal codes from the transmission processing circuit, generate N×m touch signals based on the N×m phase-shifted orthogonal codes, and respectively transmit the N×m touch signals to the N×m touch transmission electrodes.

12. The display device of claim 11, wherein a sum signal of N first frequency touch signals among the N×m touch signals has equal power in N/m code symbols among the N code symbols, and is canceled out in remaining (N−N/m) code symbols among the N code symbols.

13. The display device of claim 12, wherein a sum signal of k-th frequency touch signals has equal power in N/m other code symbols among the remaining (N−N/m) code symbols where the sum signal of the N first frequency touch signals is canceled out, and is canceled out in other remaining (N−N/m) code symbols excluding the N/m other code symbols among the N code symbols, where k is an integer greater than or equal to 2 and less than or equal to m.

14. The display device of claim 11, wherein the orthogonal matrix is an N×N Hadamard matrix.

15. The display device of claim 11, wherein
the first phase shift matrix is determined by Equation 1,
$$Frequency separation {phase}_{Hadamard}^{1} ( N , m ) = Frequency separation {phase}_{Hadamard} ( \frac{N}{m} ) * m , \qquad [ Equation 1 ]$$
wherein in Equation 1,
$$Frequency separation {phase}_{Hadamard}^{1} ( N , m )$$
is the first phase shift matrix,
$$Frequency separation {phase}_{Hadamard} ( \frac{N}{m} )$$
is a power distribution matrix for an (N/m)×(N/m) Hadamard matrix, and
$$Frequency separation {phase}_{Hadamard} ( \frac{N}{m} ) * m$$
is obtained by concatenating the power distribution matrix m times.

16. The display device of claim 11, wherein the orthogonal matrix is an N×N Fourier matrix.

17. The display device of claim 11, wherein
the first phase shift matrix is determined by Equation 5,
$$Frequency separation {phase}_{Fourier}^{1} ( N , m ) = Frequency separation {phase}_{Fourier} ( \frac{N}{m} ) * m , \qquad [ Equation 5 ]$$
wherein in Equation 5,
$$Frequency separation {phase}_{Fourier}^{1} ( N , m )$$
is the first phase shift matrix,
$$Frequency separation {phase}_{Fourier} ( \frac{N}{m} )$$
is a power distribution matrix for an (N/m)×(N/m) Fourier matrix, and
$$Frequency separation {phase}_{Fourier} ( \frac{N}{m} ) * m$$
is obtained by concatenating the power distribution matrix m times.

18. The display device of claim 11, wherein
the touch sensor further includes a plurality of touch reception electrodes, and
the touch controller further includes:
a plurality of reception channel circuits connected to the plurality of touch reception electrodes, respectively, each of the plurality of reception channel circuits receiving a sum signal of the N×m touch signals through a corresponding one of the plurality of touch reception electrodes, and generating sum signal data by performing an analog-to-digital converting operation on the sum signal; and
a reception processing circuit that receives the sum signal data from the each of the plurality of reception channel circuits, and generates touch signal data for the N×m touch signals by performing a decoding operation on the sum signal data.

19. An electronic device comprising:
a processor;
a memory connected to the processor;
a power module connected to the processor; and
a display device that receives input image data from the processor, and displays an image based on the input image data, the display device comprising:
a display panel including a plurality of pixels;
a touch sensor including N×m touch transmission electrodes, where each of N and m is an integer greater than or equal to 2;
a display driver that drives the plurality of pixels; and
a touch controller that drives the touch sensor, the touch controller including:
a transmission processing circuit that stores an orthogonal matrix including N orthogonal codes, and first through m-th phase shift matrices respectively associated with first through m-th frequencies, and generates N×m phase-shifted orthogonal codes by applying the first through m-th phase shift matrices to the N orthogonal codes; and
N×m transmission channel circuits that respectively receive the N×m phase-shifted orthogonal codes from the transmission processing circuit, generate N×m touch signals based on the N×m phase-shifted orthogonal codes, and respectively transmit the N×m touch signals to the N×m touch transmission electrodes.

20. The electronic device of claim 19, wherein
a sum signal of N first frequency touch signals among the N×m touch signals has equal power in N/m code symbols among the N code symbols, and is canceled out in remaining (N−N/m) code symbols among the N code symbols, and
a sum signal of k-th frequency touch signals has equal power in N/m other code symbols among the remaining (N−N/m) code symbols where the sum signal of the N first frequency touch signals is canceled out, and is canceled out in other remaining (N−N/m) code symbols excluding the N/m other code symbols among the N code symbols, where k is an integer greater than or equal to 2 and less than or equal to m.
